(19) United States
(12) Patent Application Publication
(10) Pub. No.: US 2022/0227349 A1
(43) Pub. Date: Jul. 21, 2022

(54) CONTROL APPARATUS FOR HYBRID ELECTRIC VEHICLE

(71) Applicant: TOYOTA JIDOSHA KABUSHIKI KAISHA, Toyota-shi (JP)

(72) Inventors: Hironobu ARATAKE, Chiryu-shi (JP); Yoshiaki TSURUTA, Nagakute-shi (JP); Yoshio HASEGAWA, Chiryu-shi (JP); Takahiko TSUTSUMI, Nisshin-shi (JP)

(73) Assignee: TOYOTA JIDOSHA KABUSHIKI KAISHA, Toyota-shi (JP)

(21) Appl. No.: 17/578,701

(22) Filed: Jan. 19, 2022

(30) Foreign Application Priority Data
Jan. 21, 2021 (JP) 2021-008333

(51) Int. Cl. B60W 20/15; B60W 30/182; B60W 10/06; B60W 10/08; B60W 10/119; B60W 10/26; B60W 20/14; B60W 50/08

(52) U.S. Cl. CPC B60W 20/15; B60W 30/182; B60W 10/06; B60W 50/08; B60W 10/119; B60W 10/26; B60W 20/14; B60W 10/08

(57) ABSTRACT

A control apparatus for a hybrid electric vehicle includes: an engine control portion configured to control an operation state of an engine in accordance with an engine operation condition; and a driving-mode control portion configured to control the vehicle so as to realize selected at least one of driving modes. The driving modes include a towing mode in which the vehicle tows a towed vehicle, a main-drive-wheel driving mode in which a drive power is distributed to main drive wheels, and an all-wheel driving mode in which the drive power is distributed to the main drive wheels and auxiliary drive wheels. The engine operation condition is determined such that an engine operation ratio is higher in a case in which the towing mode is selected, than in a case in which the all-wheel driving mode is selected without the towing mode being selected.

This application claims priority from Japanese Patent Application No. 2021-008333 filed on Jan. 21, 2021, the disclosure of which is herein incorporated by reference in its entirety.

### FIELD OF THE INVENTION

The present invention relates to a control apparatus for a hybrid electric vehicle that includes an engine and an electric motor.

### BACKGROUND OF THE INVENTION

There is well-known a control apparatus or a drive apparatus for a hybrid electric vehicle that includes an engine and an electric motor. A drive apparatus for a hybrid electric vehicle described in JP2016-179780A is an example of such a drive apparatus. This Japanese Patent Application Publication discloses driving modes including a first mode and a second mode, wherein a power performance is more important than an energy efficiency in the second mode as compared with in the first mode, and wherein the engine is started if the engine is in its stopped state when the first mode is to be switched to the second mode. The Japanese Patent Application Publication further discloses a transfer low driving mode and a towing driving mode that belong to the second mode. In the transfer low driving mode, the vehicle runs with a low gear position being established in a transmission provided in a transfer that is configured to distribute a drive power to front and rear drive wheels. In the towing driving mode, the vehicle runs while towing another vehicle as a towed vehicle.

### SUMMARY OF THE INVENTION

By the way, if an engine operation condition for starting and stopping the engine is set uniformly for securing a sufficient drive power and improving a drivability, there is a case in which an operation ratio of the engine is increased more than necessary and accordingly an energy efficiency is reduced, for example, in a towing mode (in which the vehicle runs while towing the towed vehicle) and in an all-wheel driving mode (in which the vehicle runs with the drive power being distributed to main drive wheels and auxiliary drive wheels). For example, in the towing mode, a large drive power is necessarily required when the vehicle is to start running and is to be accelerated. On the other hand, in the all-wheel driving mode, there is a case in which a large drive power is not necessarily required.

The present invention was made in view of the background art described above. It is therefore an object of the present invention to provide a control apparatus for a hybrid electric vehicle, which is capable of suppressing reduction of a drivability of the vehicle and improving an energy efficiency.

The object indicated above is achieved according to the following aspects of the present invention.

According to a first aspect of the invention, there is provided a control apparatus for a hybrid electric vehicle that includes an engine, an electric motor, main and auxiliary drive wheels and a drive-power distribution device configured to distribute a drive power to the main and auxiliary drive wheels, the control apparatus comprising: an engine control portion configured to control an operation state of the engine in accordance with an engine operation condition for starting and stopping the engine; and a driving-mode control portion configured to control running of the vehicle so as to realize selected at least one of driving modes which is selected by a driver of the vehicle or which is automatically selected, wherein the driving modes include a towing mode in which the vehicle is to run while towing a towed vehicle, a main-drive-wheel driving mode in which the vehicle is to run with the drive power being distributed to the main drive wheels, and an all-wheel driving mode in which the vehicle is to run with the drive power being distributed to the main drive wheels and the auxiliary drive wheels, and wherein the engine operation condition is determined such that an engine operation ratio, which is a ratio of an operation time of the engine to an operation time of the vehicle, is higher in a case in which the towing mode is selected, than in a case in which the all-wheel driving mode is selected without the towing mode being selected. It is noted that the driving-mode control portion may be defined also as a control portion configured to control a vehicle power transmission apparatus (that is described below) so as to realize selected at least one of driving modes which is selected by a driver of the vehicle or which is automatically selected.

According to a second aspect of the invention, in the control apparatus according to the first aspect of the invention, the engine operation condition is determined such that the engine operation ratio is higher in a case in which the towing mode or the all-wheel driving mode is selected, than in the case in which the main-drive-wheel driving mode is selected without the towing mode being selected.

According to a third aspect of the invention, in the control apparatus according to the second aspect of the invention, the engine operation condition includes an engine intermittent-operation condition related to an engine intermittent operation in which the engine is placed alternately in an operated state and a stopped state, wherein the engine intermittent-operation condition is determined, such that the engine intermittent operation is inhibited in the case in which the towing mode or the all-wheel driving mode is selected, and such that the engine intermittent operation is allowed in the case in which the main-drive-wheel driving mode is selected without the towing mode being selected.

According to a fourth aspect of the invention, in the control apparatus according to the first aspect of the invention, the engine operation condition includes an engine start condition related to starting of the engine, wherein the engine start condition is determined, such that, in a case in which the towing mode is selected when the vehicle is in a predetermined state, the starting of the engine is initiated at a point of time at which the towing mode is selected, and such that, in a case in which the all-wheel driving mode is selected without the towing mode being selected when the vehicle is in the predetermined state, the starting of the engine is initiated at a point of time at which a predetermined request is made in the vehicle after the all-wheel driving mode is selected.

According to a fifth aspect of the invention, in the control apparatus according to the fourth aspect of the invention, wherein the vehicle includes a vehicle power transmission apparatus including the drive-power distribution device and configured to transmit the drive power toward the main and auxiliary drive wheels, wherein the predetermined state is (i) a state in which the vehicle is stopped with the vehicle power transmission apparatus being placed in a forward driving position that enables the drive power to be transmitted to drive the vehicle in a forward direction, or (ii) a state in which the vehicle is stopped with the vehicle power transmission apparatus being placed in a neutral position that disables the drive power to be transmitted without an output rotary member of the vehicle power transmission apparatus being mechanically fixed to be unrotatable, and wherein the predetermined request is (iii) a request of an acceleration of the vehicle that increases the drive power, or (iv) a request of a charge of an electric storage device configured to supply and receive an electric power to and from the electric motor.

According to a sixth aspect of the invention, in the control apparatus according to the fourth aspect of the invention, the drive-power distribution device includes a transmission in which a selected one of a low gear position and a high gear position is to be established by operation of a dog clutch, wherein the all-wheel driving mode is categorized into a low-gear all-wheel driving mode in which the low gear position is established in the transmission and a high-gear all-wheel driving mode in which the high gear position is established in the transmission, wherein the main-drive-wheel driving mode is a high-gear main-drive-wheel driving mode in which the high gear position is established in the transmission, and wherein the control apparatus further comprises an electric-motor control portion that is configured to cause the electric motor to output a predetermined torque causing a creep phenomenon in a state in which the engine is held in the stopped state, in a case in which the high-gear main-drive-wheel driving mode is switched to the high-gear all-wheel driving mode with the high-gear all-wheel driving mode being selected in the high-gear main-drive-wheel driving mode when each of the engine and the electric motor is in the stopped state.

According to a seventh aspect of the invention, there is provided a control apparatus for a hybrid electric vehicle that includes an engine and an electric motor, the control apparatus comprising: an engine control portion configured to control an operation state of the engine in accordance with an engine operation condition for starting and stopping the engine; and a driving-mode control portion configured to control running of the vehicle so as to realize selected at least one of driving modes which is selected by a driver of the vehicle or which is automatically selected, wherein the driving modes include a first towing mode in which the vehicle is to run while towing a towed vehicle, and a second towing mode in which the vehicle is to run while towing a towed vehicle, and wherein the engine operation condition is determined such that an engine operation ratio, which is a ratio of an operation time of the engine to an operation time of the vehicle, is higher in a case in which the first towing mode is selected, than in a case in which the second towing mode is selected.

According to an eighth aspect of the invention, in the control apparatus according to the seventh aspect of the invention, the towed vehicle towed by the vehicle in the second towing mode has a total weight lighter than a total weight of the towed vehicle towed by the vehicle in the first towing mode.

According to a ninth aspect of the invention, in the control apparatus according to the seventh aspect of the invention, there is further provided a driving control portion configured to execute (i) a manual drive control for driving the vehicle in accordance with driving operations made by the driver of the vehicle and (ii) a drive assist control for driving the vehicle by automatically performing at least acceleration and deceleration of the vehicle, wherein the first towing mode is selected when the vehicle is to run while towing the towed vehicle during execution of the manual drive control, and wherein the second towing mode is selected when the vehicle is to run while towing the towed vehicle during execution of the drive assist control.

According to a tenth aspect of the invention, in the control apparatus according to the seventh aspect of the invention, the driving modes include a charge-amount sustaining mode and a charge-amount consuming mode, wherein, in the charge-amount sustaining mode, an engine intermittent operation in which the engine is placed alternately in an operated state and a stopped state is executed, and a motor driving of the vehicle with only the electric motor serving as a drive power source is enabled when the engine is in the stopped state, wherein, in the charge-amount consuming mode, the motor driving is continued more than in the charge-amount sustaining mode, wherein the first towing mode is selected when the vehicle is to run while towing the towed vehicle during execution of the charge-amount sustaining mode, and wherein the second towing mode is selected when the vehicle is to run while towing the towed vehicle during execution of the charge-amount consuming mode.

According to an eleventh aspect of the invention, in the control apparatus according to the seventh aspect of the invention, the driving modes include an engine brake mode and a regenerative brake mode, wherein, in the engine brake mode, an engine brake torque owing to resistance to rotation of the engine is generated by during deceleration running of the vehicle, wherein, in the regenerative brake mode, a regenerative brake torque owing to regeneration of the electric motor, rather than the engine brake torque, is preferentially generated during the deceleration running of the vehicle, wherein the first towing mode is selected when the vehicle is to run while towing the towed vehicle with the engine brake mode being selected, and wherein the second towing mode is selected when the vehicle is to run while towing the towed vehicle with the regenerative brake mode being selected.

According to a twelfth aspect of the invention, in the control apparatus according to the seventh aspect of the invention, the vehicle further includes main and auxiliary drive wheels and a drive-power distribution device configured to distribute a drive power to the main and auxiliary drive wheels, wherein the driving modes include an all-wheel driving mode and a main-drive-wheel driving mode, wherein, in the all-wheel driving mode, the vehicle is to run with the drive power being distributed through the drive-power distribution device to the main drive wheels and the auxiliary drive wheels, wherein, in the main-drive-wheel driving mode, the vehicle is to run with the drive power being distributed through the drive-power distribution device to the main drive wheels, wherein the first towing mode is selected when the vehicle is to run while towing the towed vehicle with the all-wheel driving mode being selected, and wherein the second towing mode is selected when the vehicle is to run while towing the towed vehicle with the main-drive-wheel driving mode being selected.

According to a thirteenth aspect of the invention, there is provided a control apparatus for a hybrid electric vehicle that includes an engine, an electric motor, main and auxiliary drive wheels and a drive-power distribution device configured to distribute a drive power to the main and auxiliary drive wheels, the control apparatus comprising: an engine control portion configured to control an operation state of the engine in accordance with an engine operation condition for starting and stopping the engine; and a driving-mode control portion configured to control running of the vehicle so as to realize selected at least one of driving modes which is selected by a driver of the vehicle or which is automatically selected, wherein the driving modes include a first all-wheel driving mode in which the vehicle is to run with the drive power being distributed to the main drive wheels and the auxiliary drive wheels, and a second all-wheel driving mode in which the vehicle is to run with the drive power being distributed to the main drive wheels and the auxiliary drive wheels, and wherein the engine operation condition is determined such that an engine operation ratio, which is a ratio of an operation time of the engine to an operation time of the vehicle, is higher in a case in which the first all-wheel driving mode is selected, than in a case in which the second all-wheel driving mode is selected.

According to a fourteenth aspect of the invention, in the control apparatus according to the thirteenth aspect of the invention, there is further provided a driving control portion configured to execute (i) a manual drive control for driving the vehicle in accordance with driving operations made by the driver of the vehicle and (ii) a drive assist control for driving the vehicle by automatically performing at least acceleration and deceleration of the vehicle, wherein the first all-wheel driving mode is selected when the vehicle is to run with the drive power being distributed to the main drive wheels and the auxiliary drive wheels during execution of the manual drive control, and wherein the second all-wheel driving mode is selected when the vehicle is to run with the drive power being distributed to the main drive wheels and the auxiliary drive wheels during execution of the drive assist control.

According to a fifteenth aspect of the invention, in the control apparatus according to the thirteenth aspect of the invention, the driving modes include a charge-amount sustaining mode and a charge-amount consuming mode, wherein, in the charge-amount sustaining mode, an engine intermittent operation in which the engine is placed alternately in an operated state and a stopped state is executed, and a motor driving of the vehicle with only the electric motor serving as a drive power source is enabled when the engine is in the stopped state, wherein, in the charge-amount consuming mode, the motor driving is continued more than in the charge-amount sustaining mode, wherein the first all-wheel driving mode is selected when the vehicle is to run with the drive power being distributed to the main drive wheels and the auxiliary drive wheels during execution of the charge-amount sustaining mode, and wherein the second all-wheel driving mode is selected when the vehicle is to run with the drive power being distributed to the main drive wheels and the auxiliary drive wheels during execution of the charge-amount consuming mode.

According to a sixteenth aspect of the invention, in the control apparatus according to the thirteenth aspect of the invention, the driving modes include an engine brake mode and a regenerative brake mode, wherein, in the engine brake mode, an engine brake torque owing to resistance to rotation of the engine is generated by during deceleration running of the vehicle, wherein, in the regenerative brake mode, a regenerative brake torque owing to regeneration of the electric motor, rather than the engine brake torque, is preferentially generated during the deceleration running of the vehicle, wherein the first all-wheel driving mode is selected when the vehicle is to run with the drive power being distributed to the main drive wheels and the auxiliary drive wheels with the engine brake mode being selected, and wherein the second all-wheel driving mode is selected when the vehicle is to run with the drive power being distributed to the main drive wheels and the auxiliary drive wheels with the regenerative brake mode being selected.

According to a seventeenth aspect of the invention, in the control apparatus according to the thirteenth aspect of the invention, the driving modes include a towing mode in which the vehicle is to run while towing a towed vehicle, wherein the first all-wheel driving mode is selected when the vehicle is to run with the drive power being distributed to the main drive wheels and the auxiliary drive wheels with the towing mode being selected, and wherein the second all-wheel driving mode is selected when the vehicle is to run with the drive power being distributed to the main drive wheels and the auxiliary drive wheels with the towing mode being not selected.

In the control apparatus according to the first aspect of the invention, the engine operation condition for starting and stopping the engine is determined such that the engine operation ratio is higher in the case in which the towing mode is selected, than in the case in which the all-wheel driving mode is selected without the towing mode being selected. This control arrangement makes it possible to easily secure a sufficient drive power in the case in which the towing mode is selected, and to easily improve an energy efficiency in the case in which the all-wheel driving mode is selected without the towing mode being selected. That is, the engine is started and stopped in manners that vary depending on whether the towing mode or the all-wheel driving mode is selected, wherein the towing mode is a mode in which a large drive power is necessarily required when the vehicle is to start running and is to be accelerated, while the all-wheel driving mode is a mode in which a large drive power is not necessarily required. It is therefore possible to suppress reduction of a drivability of the vehicle and improve an energy efficiency.

In the control apparatus according to the second aspect of the invention, the engine operation condition is determined such that the engine operation ratio is higher in the case in which the towing mode or the all-wheel driving mode is selected, than in the case in which the main-drive-wheel driving mode is selected without the towing mode being selected, so that the required drive power is easily secured not only when the towing mode is selected but also when the all-wheel driving mode is selected.

In the control apparatus according to the third aspect of the invention, the engine operation condition includes the engine intermittent-operation condition that is determined, such that the engine intermittent operation is inhibited in the case in which the towing mode or the all-wheel driving mode is selected, and such that the engine intermittent operation is allowed in the case in which the main-drive-wheel driving mode is selected without the towing mode being selected, so that the required drive power is further easily secured not only when the towing mode is selected but also when the all-wheel driving mode is selected.

In the control apparatus according to the fourth aspect of the invention, the engine operation condition includes the engine start condition that is determined, such that, in the case in which the towing mode is selected when the vehicle is in the predetermined state, the starting of the engine is initiated at the point of time at which the towing mode is selected, and such that, in the case in which the all-wheel driving mode is selected without the towing mode being selected when the vehicle is in the predetermined state, the starting of the engine is initiated at the point of time at which the predetermined request is made in the vehicle after the all-wheel driving mode is selected, so that the sufficient drive power is easily secured when the vehicle is to start running and is to be accelerated in the case in which the towing mode is selected, and the energy efficiency is easily improved in the case in which the all-wheel driving mode is selected.

In the control apparatus according to the fifth aspect of the invention, the predetermined state is (i) the state in which the vehicle is stopped with the vehicle power transmission apparatus being placed in the forward driving position or (ii) the state in which the vehicle is stopped with the vehicle power transmission apparatus being placed in the neutral position, and the predetermined request is (iii) the request of the acceleration of the vehicle or (iv) the request of the charge of the electric storage device, so that the sufficient drive power is easily secured when the vehicle is to start running in the case in which the towing mode is selected, and the energy efficiency is easily improved in the case in which the all-wheel driving mode is selected.

In the control apparatus according to the sixth aspect of the invention, the electric motor is caused to output the predetermined torque causing the creep phenomenon in the state in which the engine is held in the stopped state, in the case in which the high-gear main-drive-wheel driving mode is switched to the high-gear all-wheel driving mode with the high-gear all-wheel driving mode being selected in the high-gear main-drive-wheel driving mode when each of the engine and the electric motor is in the stopped state, so that it is possible to easily obtain rotation required by the operation of the dog clutch in the transmission provided in the drive-power distribution device in the high-gear all-wheel driving mode. Owing to this control arrangement, the switching to the low-gear all-wheel driving mode can be reliably made even when the engine is placed in the stopped state after the high-gear main-drive-wheel driving mode is switched to the high-gear all-wheel driving mode.

In the control apparatus according to the seventh aspect of the invention, the engine operation condition for starting and stopping the engine is determined such that the engine operation ratio is higher in the case in which the first towing mode is selected, than in the case in which the second towing mode is selected. This control arrangement makes it possible to easily secure the sufficient drive power in the case in which the first towing mode is selected, and to easily improve the energy efficiency in the case in which the second towing mode is selected. That is, even in the towing mode in which the large drive power is required when the vehicle is to start running and is to be accelerated, it is possible to increase a situation in which the engine is in the stopped state. It is therefore possible to improve the energy efficiency while suppressing the reduction of the drivability of the vehicle.

In the control apparatus according to the eighth aspect of the invention, the towed vehicle towed by the vehicle in the second towing mode has the total weight lighter than the total weight of the towed vehicle towed by the vehicle in the first towing mode. Therefore, it is possible to increase the situation in which the engine is in the stopped state, in the second towing mode in which the power performance is less important than in the first towing mode, although the second towing mode as well as the first towing mode is the towing mode in which the large drive power is required when the vehicle is to start running and is to be accelerated.

In the control apparatus according to the ninth aspect of the invention, the first towing mode is selected when the vehicle is to run while towing the towed vehicle during execution of the manual drive control, and the second towing mode is selected when the vehicle is to run while towing the towed vehicle during execution of the drive assist control. Therefore, it is possible to increase the situation in which the engine is in the stopped state, during execution of the drive assist control during which the required drive power tends to have a higher degree of freedom than during execution of the manual drive control, although the second towing mode as well as the first towing mode is the towing mode in which the large drive power is required when the vehicle is to start running and is to be accelerated.

In the control apparatus according to the tenth aspect of the invention, the first towing mode is selected when the vehicle is to run while towing the towed vehicle during execution of the charge-amount sustaining mode, and the second towing mode is selected when the vehicle is to run while towing the towed vehicle during execution of the charge-amount consuming mode during which the motor running can be continued more than during execution of the charge-amount sustaining mode. Therefore, it is possible to increase the situation in which the engine is in the stopped state, during execution of the charge-amount consuming mode during which the energy efficiency rather than the power performance is more important as compared with during execution of the charge-amount sustaining mode, although the second towing mode as well as the first towing mode is the towing mode in which the large drive power is required when the vehicle is to start running and is to be accelerated.

In the control apparatus according to the eleventh aspect of the invention, the first towing mode is selected when the vehicle is to run while towing the towed vehicle with the engine brake mode being selected, and the second towing mode is selected when the vehicle is to run while towing the towed vehicle with the regenerative brake mode being selected. Therefore, it is possible to increase the situation in which the engine is in the stopped state, in the regenerative brake mode in which the energy efficiency is more important, than in the engine brake mode in which the engine requires to be kept in the rotated state, although the second towing mode as well as the first towing mode is the towing mode in which the large drive power is required when the vehicle is to start running and is to be accelerated.

In the control apparatus according to the twelfth aspect of the invention, the first towing mode is selected when the vehicle is to run while towing the towed vehicle with the all-wheel driving mode being selected, and the second towing mode is selected when the vehicle is to run while towing the towed vehicle with the main-drive-wheel driving mode being selected. Therefore, it is possible to increase the situation in which the engine is in the stopped state, in the main-drive-wheel driving mode in which the power performance is less important, than in the all-wheel driving mode, although the second towing mode as well as the first towing mode is the towing mode in which the large drive power is required when the vehicle is to start running and is to be accelerated.

In the control apparatus according to the thirteenth aspect of the invention, the engine operation condition for starting and stopping the engine is determined such that an engine operation ratio is higher in the case in which the first all-wheel driving mode is selected, than in the case in which the second all-wheel driving mode is selected. This control arrangement makes it possible to easily secure the sufficient drive power in the case in which the first all-wheel driving mode is selected, and to easily improve the energy efficiency in the case in which the second all-wheel driving mode is selected. That is, even in the all-wheel driving mode in which the large drive power is required, it is possible to increase the situation in which the engine is in the stopped state. It is therefore possible to improve the energy efficiency while suppressing the reduction of the drivability of the vehicle.

In the control apparatus according to the fourteenth aspect of the invention, the first all-wheel driving mode is selected when the vehicle is to run with the drive power being distributed to the main drive wheels and the auxiliary drive wheels during execution of the manual drive control, and the second all-wheel driving mode is selected when the vehicle is to run with the drive power being distributed to the main drive wheels and the auxiliary drive wheels during execution of the drive assist control. Therefore, it is possible to increase the situation in which the engine is in the stopped state, during execution of the drive assist control during which the required drive power tends to have a higher degree of freedom than during execution of the manual drive control, although the second all-wheel driving mode as well as the first all-wheel driving mode is the all-wheel driving mode in which the large drive power is required.

In the control apparatus according to the fifteenth aspect of the invention, the first all-wheel driving mode is selected when the vehicle is to run with the drive power being distributed to the main drive wheels and the auxiliary drive wheels during execution of the charge-amount sustaining mode, and the second all-wheel driving mode is selected when the vehicle is to run with the drive power being distributed to the main drive wheels and the auxiliary drive wheels during execution of the charge-amount consuming mode during which the motor running can be continued more than during execution of the charge-amount sustaining mode. Therefore, it is possible to increase the situation in which the engine is in the stopped state, during execution of the charge-amount consuming mode during which the energy efficiency rather than the power performance is more important as compared with during execution of the charge-amount sustaining mode, although the second all-wheel driving mode as well as the first all-wheel driving mode is the all-wheel driving mode in which the large drive power is required.

In the control apparatus according to the sixteenth aspect of the invention, the first all-wheel driving mode is selected when the vehicle is to run with the drive power being distributed to the main drive wheels and the auxiliary drive wheels with the engine brake mode being selected, and the second all-wheel driving mode is selected when the vehicle is to run with the drive power being distributed to the main drive wheels and the auxiliary drive wheels with the regenerative brake mode being selected. Therefore, it is possible to increase the situation in which the engine is in the stopped state, in the regenerative brake mode in which the energy efficiency is more important, than in the engine brake mode in which the engine requires to be kept in the rotated state, although the second all-wheel driving mode as well as the first all-wheel driving mode is the all-wheel driving mode in which the large drive power is required.

In the control apparatus according to the seventeenth aspect of the invention, the first all-wheel driving mode is selected when the vehicle is to run with the drive power being distributed to the main drive wheels and the auxiliary drive wheels with the towing mode being selected, and the second all-wheel driving mode is selected when the vehicle is to run with the drive power being distributed to the main drive wheels and the auxiliary drive wheels with the towing mode being not selected. Therefore, it is possible to increase the situation in which the engine is in the stopped state, when the towing mode is not selected with the power performance being less important than when the towing mode is selected, although the second all-wheel driving mode as well as the first all-wheel driving mode is the all-wheel driving mode in which the large drive power is required.

### BRIEF DESCRIPTION OF THE DRAWINGS

FIG. 1 is a view schematically showing a construction of a vehicle to which the present invention is applied, for explaining major portions of control functions and control systems that are provided to perform various control operations in the vehicle;

FIG. 2 is a view schematically showing a construction of a transfer shown in FIG. 1;

FIG. 3 is a flow chart showing a main part of a control routine executed by an electronic control apparatus, namely, a control routine that is executed for suppressing reduction of drivability of the vehicle and improving an energy efficiency;

FIG. 4 is a view schematically showing a construction of a vehicle to which the present invention is applied, for explaining major portions of control functions and control systems that are provided to perform various control operations in the vehicle, in embodiments other than an embodiment shown in FIG. 1;

FIG. 5 is a flow chart showing a main part of a control routine executed by the electronic control apparatus, namely, a control routine that is executed for suppressing reduction of drivability of the vehicle and improving the energy efficiency, wherein the control routine is different from that shown in FIG. 3; and

FIG. 6 is a flow chart showing a main part of a control routine executed by the electronic control apparatus, namely, a control routine that is executed for suppressing reduction of drivability of the vehicle and improving the energy efficiency, wherein the control routine is different from those shown in FIGS. 3 and 5.

### DETAILED DESCRIPTION OF PREFERRED EMBODIMENTS

Hereinafter, preferred embodiments of the invention will be described in detail with reference to the accompanying drawings.

### First Embodiment

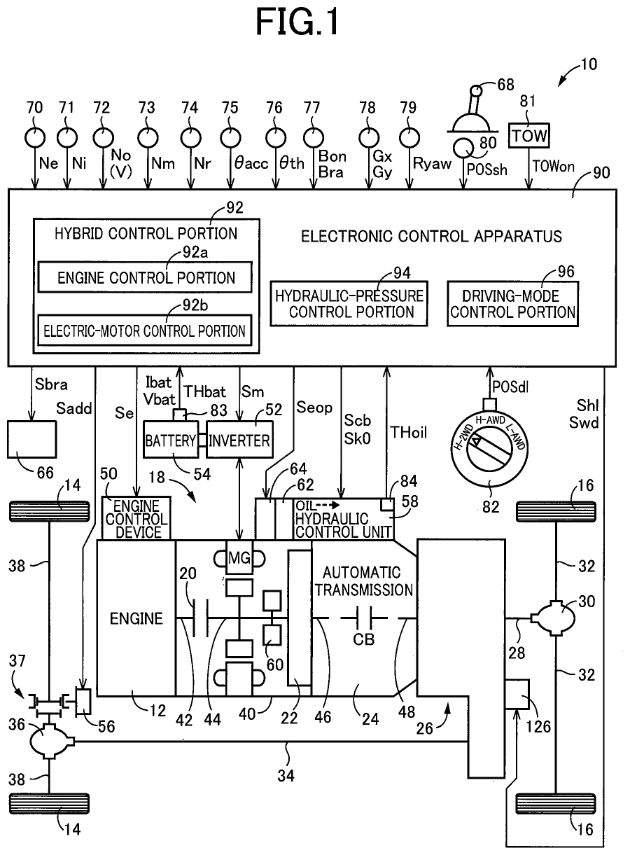

FIG. 1 is a view schematically showing a construction of a vehicle 10 to which the present invention is applied, for explaining major portions of control functions and control systems that are provided to perform various control operations in the vehicle 10. As shown in FIG. 1, the vehicle 10 is a hybrid electric vehicle including drive power sources in the form of an engine 12 and an electric motor MG The vehicle 10 further includes right and left front wheels 14, right and left rear wheels 16 and a power transmission apparatus 18 that serves as a vehicle power transmission apparatus configured to transmit a drive power from the engine 12, for example, to the front wheels 14 and the rear wheels 16.

The vehicle 10 is an all-wheel drive vehicle based on a main-drive-wheel drive vehicle of FR (front engine and rear drive) system. The vehicle 10 is also a four-wheel drive vehicle based on a two-wheel drive vehicle of FR (front engine and rear drive) system, since the vehicle 10 has four wheels consisting of the two front wheels 14 and the two rear wheels 16. In the description of the present embodiment, a main-drive-wheel drive is synonymous with a two-wheel drive (=2WD), and an all-wheel drive (=AWD) is synonymous with a four-wheel drive (=4WD). The rear wheels 16 are main drive wheels serving as drive wheels during both of a 2WD running and an AWD running of the vehicle 10. The front wheels 14 are auxiliary drive wheels serving as driven wheels during the 2WD running and serving as the drive wheel during the AWD running. The 2WD running is a running in a 2WD state in which the drive power is transmitted to the rear wheels 16. The AWD running is a running in an AWD state in which the drive power is transmitted to the rear wheels 16 and the front wheels 14.

The engine 12 is a known internal combustion engine such as gasoline engine and diesel engine. The vehicle 10 is provided with an engine control device 50 that includes a throttle actuator, a fuel injection device and an ignition device. With the engine control device 50 being controlled by an electronic control apparatus 90 that is described below, an engine torque Te, which is an output torque of the engine 12, is controlled.

The electric motor MG is a rotating electric machine having a function serving as a motor configured to generate a mechanical power from an electric power and a function serving as a generator configured to generate an electric power from a mechanical power. That is, the electric motor MG is a so-called “motor generator”. The electric motor MG is connected to a battery 54 provided in the vehicle 10, through an inverter 52 provided in the vehicle 10. The battery 54 is an electric storage device configured to supply and receive an electric power to and from the electric motor MG The inverter 52 is controlled by the electronic control apparatus 90 whereby an MG torque Tm as an output torque of the electric motor MG is controlled. The MG torque Tm serves as a power running torque when acting as a positive torque for acceleration, with the electric motor MG being rotated in a forward direction that is the same as a direction of rotation of the engine 12 during operation of the engine 12. The MG torque Tm serves as a regenerative torque when acting as a negative torque for deceleration, with the electric motor MG being rotated in the forward direction. The electric power corresponds to an electric energy unless they are to be distinguished from each other. The power corresponds to a torque and a force unless they are to be distinguished from one another.

The power transmission apparatus 18 includes a casing 40 as a non-rotary member that is attached to a body of the vehicle 10, a K0 clutch 20, a torque converter 22, an automatic transmission 24, a transfer 26, a rear propeller shaft 28, a rear differential device 30, right and left rear drive shafts 32, a front propeller shaft 34, a front differential device 36 and right and left front drive shafts 38, such that the K0 clutch 20, torque converter 22 and automatic transmission 24 are disposed inside the casing 40. The power transmission apparatus 18 further includes an engine connection shaft 42 and an electric-motor connection shaft 44 that disposed inside the casing 40. The engine connection shaft 42 connects between the engine 12 and the K0 clutch 20. The electric-motor connection shaft 44 connects between the K0 clutch 20 and the torque converter 22.

The K0 clutch 20 is a clutch disposed in a power transmission path between the engine 12 and the torque converter 22, so that the torque converter 22 is to be connected to the engine 12 through the K0 clutch 20. The automatic transmission 24 is disposed in a power transmission path between the torque converter 22 and the transfer 26, so that the torque converter 22 is connected to a transmission input shaft 46 that is an input rotary member of the automatic transmission 24, and the transfer 26 is connected to a transmission output shaft 48 that is an output rotary member of the automatic transmission 24.

In the casing 40, the electric motor MG is connected to the electric-motor connection shaft 44 in a power transmittable manner. That is, the electric motor MG is connected to a power transmission path between the K0 clutch 20 and the torque converter 22, in a power transmittable manner. From a different point of view, the electric motor MG is connected to the torque converter 22 and the automatic transmission 24 in a power transmittable manner, without through the K0 clutch 20.

The torque converter 22 is a fluid-type transmission device configured to transmit the drive power of the drive power sources in the form of the engine 12 and the electric motor MG, to the transmission input shaft 46, through fluid circulating in the torque converter 22. The automatic transmission 24 is a mechanical-type transmission device configured to transmit the drive power of the drive power sources in the form of the engine 12 and the electric motor MG to the transfer 26.

The front differential device 36 is a differential device provided with an ADD (Automatic Disconnecting Differential) mechanism 37 that is constituted by, for example, a dog clutch serving as a connection/disconnection clutch. The front differential device 36 is placed in its locked state, with an operation state, i.e., a controlled state of the ADD mechanism 37 being placed in its engaged state. The front differential device 36 is placed in its free state, with the controlled state of the ADD mechanism 37 being placed in its released state. The controlled state of the ADD mechanism 37 is switched, with an ADD-mechanism actuator 56 (provided in the vehicle 10) being controlled by the electronic control apparatus 90.

The automatic transmission 24 is a known automatic transmission of a planetary gear type which includes at least one planetary gear device (not shown) and a plurality of engagement devices CB. Each of the engagement devices CB is a known hydraulically-operated frictional engagement device, for example. Each of the engagement devices CB receives a regulated CB hydraulic pressure PRcb supplied from a hydraulic control unit (hydraulic control circuit) 58 that is provided in the vehicle 10, whereby a CB torque Tcb, i.e., torque capacity is changed and its controlled state is switched between an engaged state and a released state, for example. The hydraulic control unit 58 is to be controlled by the electronic control apparatus 90.

The automatic transmission 24 is a step-variable automatic transmission configured to establish a selected one of a plurality of gear positions, with a corresponding one or ones of the engagement devices CB being engaged, wherein the gear positions are different from each other in gear ratio (speed ratios) γat (=AT input rotational speed Ni/AT output rotational speed No). The automatic transmission 24 is configured to switch from one of the AT gear positions to another one of the AT gear positions, namely, to establish one of the AT gear positions which is selected, by the electronic control apparatus 90, depending on, for example, an accelerating operation made by a vehicle driver (operator) and the vehicle running speed V. The AT input rotational speed Ni is a rotational speed of the transmission input shaft 46, and is an input rotational speed of the automatic transmission 24. The AT output rotational speed No is a rotational speed of the transmission output shaft 48, and is an output rotational speed of the automatic transmission 24.

The K0 clutch 20 is a hydraulically-operated frictional engagement device in the form of a multiple-disc type or a single-disc type clutch that is to be pressed by a hydraulic actuator, for example. The K0 clutch 20 receives a regulated K0 hydraulic pressure PRk0 supplied from the hydraulic control unit 58, whereby a K0 clutch torque Tk0, i.e., torque capacity of the K0 clutch 20 is changed and its operation state is switched between the engaged state and the released state, for example.

The transfer 26 is configured to selectively connect and cut-off a power transmission, for example, between the rear propeller shaft 28 and the front propeller shaft 34, so as to transmit the drive power transmitted from the automatic transmission 24, to only the rear wheels 16 or to the front and rear wheels 14, 16. Thus, the transfer 26 distributes the drive power to the rear wheels 16 as the main drive wheels and the front wheels 14 as the auxiliary drive wheels, with a ratio of distribution of the drive power between the main drive wheels and the auxiliary drive wheels being changeable.

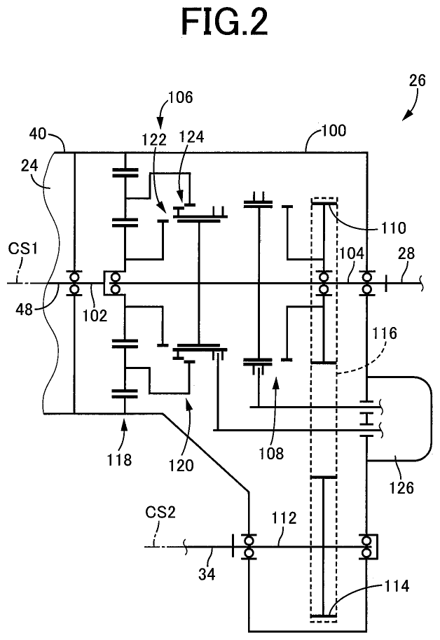

FIG. 2 is a view schematically showing a construction of the transfer 26, wherein the view is a development view illustrating the transfer 26 in a manner in which axes of an input shaft 102 and first and second output shafts 104, 112 are contained in a single plane. As shown in FIG. 2, the transfer 26 includes a non-rotary member in the form of a transfer casing 100 that is connected to one of opposite end portions of the casing 40, wherein the one of the opposite end portions is located on a rear side of the other of the opposite end portions in a direction of running of the vehicle 10. The transfer 26 further includes the input shaft 102, the first output shaft 104, an auxiliary transmission 106, a power-distribution dog clutch 108 and a drive gear 110 which are provided inside the transfer casing 100 and which are disposed on a common axis in the form of a first axis CS1. The transfer 26 further includes the second output shaft 112 and a driven gear 114 which are provided inside the transfer casing 100 and which are disposed on another common axis in the form of a second axis CS2. The transfer 26 further includes a chain 116 connecting between the drive gear 110 and the driven gear 114.

The input shaft 102 is connected to the transmission output shaft 48. The first output shaft 104 is connected to the rear propeller shaft 28. The second output shaft 112 is connected to the front propeller shaft 34. The drive gear 110 is selectively allowed to be rotated relative to the first output shaft 104, and inhibited from being rotated relative to the first output shaft 104. The driven gear 114 is unrotatable relative to the second output shaft 112.

The auxiliary transmission 106 includes a planetary gear device 118 and an auxiliary-transmission dog clutch 120 that includes a high-gear-side dog mechanism 122 and a low-gear-side dog mechanism 124. The high-gear-side dog mechanism 122 is provided to establish a high gear position GSH providing a low gear ratio and making the vehicle 10 run at a high running speed. The low-gear-side dog mechanism 124 is provided to establish a low gear position GSL providing a high gear ratio and making the vehicle 10 run at a low running speed. Each of the high-gear-side dog mechanism 122 and the low-gear-side dog mechanism 124 is constituted by a dog clutch provided with a synchronous meshing mechanism, for example. That is, the auxiliary transmission 106 is a transmission configured to establish a selected one of the low gear position GSL and the high gear position GSH, which is selected depending on an operation of the auxiliary-transmission dog clutch 120 as a dog clutch. The transfer 26 is configured to transmit rotation of the input shaft 102 to the first output shaft 104 through the auxiliary transmission 106.

The power-distribution dog clutch 108 is an engagement device configured to selectively allow the drive gear 110 to be rotated relative to the first output shaft 104 and inhibit the drive gear 110 from being rotated relative to the first output shaft 104. The power-distribution dog clutch 108 is a dog clutch provided with a synchronous meshing mechanism, for example. With the power-distribution dog clutch 108 being placed in its released state, the drive gear 110 is rotatable about the first axis CS1 relative to the first output shaft 104, whereby the power transmission between the first and second output shafts 104, 112 through the drive gear 110, chain 116 and driven gear 114, for example, is disabled. With the power-distribution dog clutch 108 being placed in its engaged state, the drive gear 110 is inhibited from being rotated about the first axis CS1 relative to the first output shaft 104, whereby the power transmission between the first and second output shafts 104, 112 through the drive gear 110, chain 116 and driven gear 114, for example, is enabled.

The transfer 26 further includes a shift actuator 126 fixed to the transfer casing 100. The shift actuator 126 is an actuator configured to operate the auxiliary-transmission dog clutch 120 and the power-distribution dog clutch 108.

Referring back to FIG. 1, when the power-distribution dog clutch 108 is placed in the engaged state in the transfer 26 and the ADD mechanism 37 is placed in the engaged state in the front differential device 36, a part of the drive power is transmitted to the second output shaft 112 through the transfer 26, and is transmitted to the front differential device 36 through the front propeller shaft 34, so that the part of the drive power is transmitted eventually to the front wheels 14 through the front drive shafts 38. Meanwhile, the remainder of the drive power, which is not transmitted to the second output shaft 112 through the transfer 26, is transmitted to the rear differential device 30 through the rear propeller shaft 28, and is transmitted eventually to the rear wheels 16 through the rear drive shafts 32. Thus, the vehicle 10 is placed in the AWD state.

On the other hand, when the power-distribution dog clutch 108 is placed in the released state in the transfer 26, the drive power is transmitted through the transfer 26 only to the rear wheels 16, so that the vehicle 10 is placed in the 2WD state. In the vehicle 10, the ADD mechanism 37 is placed in the released state, for example, when the vehicle 10 is placed in the 2WD state.

In the vehicle 10, when the K0 clutch 20 is placed in the engaged state, the engine 12 and the torque converter 22 are connected to each other in a power transmittable manner. On the other hand, when the K0 clutch 20 is placed in the released state, the power transmission between the engine 12 and the torque converter 22 is cut off. Since the electric motor MG is connected to the torque converter 22, the K0 clutch 20 serves as a clutch configured to selectively connect and disconnect the engine 12 to and from the electric motor MG.

In the power transmission apparatus 18, when the K0 clutch 20 is in the engaged state, the drive power outputted by the engine 12 is transmitted from the engine connection shaft 42 to the transfer 26 through sequentially the K0 clutch 20, electric-motor connection shaft 44, torque converter 22 and automatic transmission 24, for example. Meanwhile, the drive power outputted by the electric motor MG is transmitted from the electric-motor connection shaft 44 to the transfer 26 sequentially the torque converter 22 and automatic transmission 24, for example, irrespective of the controlled state of the K0 clutch 20. The drive power, which has been transmitted to the transfer 26, is further transmitted from the transfer 26 to the rear wheels 16 when the vehicle 10 is in the 2WD state, and is further transmitted from the transfer 26 to the front wheels 14 as well as to the rear wheels 16 when the vehicle 10 is in the AWD state.

The vehicle 10 further includes an MOP 60 that is a mechanically-operated oil pump, an EOP 62 that is an electrically-operated oil pump, and a pump motor 64. The MOP 60 is connected to the electric-motor connection shaft 44, and is to be rotated and driven by the drive power source or sources (i.e., engine 12 and/or electric motor MG), so as to output a working fluid OIL that is to be used in the power transmission apparatus 18. The pump motor 64 is a motor serving exclusively to rotate and drive the EOP 62. The EOP 62 outputs the working fluid OIL, when being rotated and driven by the pump motor 64. The working fluid OIL outputted by the MOP 60 and the EOP 62 is supplied to the hydraulic control unit 58. The hydraulic control unit 58, which receives the working fluid OIL as an original hydraulic pressure, supplies regulated hydraulic pressures that serve as the CB hydraulic pressure PRcb and the K0 hydraulic pressure PRO, for example.

The vehicle 10 is provided with a wheel brake device 66 for braking the front and rear wheels 14, 16. The wheel brake device 66 includes wheels brakes each configured to apply a brake torqueTB to a corresponding one of the front and rear wheels 14, 16. The wheel brake device 66 supplies a brake hydraulic pressure to each of wheel cylinders provided in the respective wheel brakes, for example, in response to a depressing operation of a brake pedal by the vehicle driver In the wheel brake device 66, in a normal case, a master-cylinder hydraulic pressure generated by a brake master cylinder is supplied as a brake hydraulic pressure to the wheel cylinders, wherein a magnitude of the master-cylinder hydraulic pressure corresponds to a braking operation amount Bra. On the other hand, in the wheel brake device 66, in a particular case, for example, when a particular control is executed, the brake hydraulic pressure whose magnitude corresponds to the brake torque TB required for execution of the particular control is supplied to the wheel cylinders, wherein the particular control includes an ABS control, a brake assist control, a TRC (traction control), a VSC (vehicle stability control), i.e., askidding suppression control, a vehicle running-speed control and an automatic brake control. The above-described braking operation amount Bra is a signal representing an amount of a braking operation, i.e., an amount of the depressing operation of the brake pedal, which corresponds to a depressing force applied to the brake pedal by the vehicle driver.

The vehicle 10 is further provided with the electronic control apparatus 90 which is constructed according to the present invention and which is related to control of the engine 12, for example. The electronic control apparatus 90 includes a so-called microcomputer incorporating a CPU, a ROM, a RAM and an input-output interface. The CPU performs various control operations of the vehicle 10, by processing various input signals, according to control programs stored in the ROM, while utilizing a temporary data storage function of the RAM. The electronic control apparatus 90 may be constituted by two or more control units exclusively assigned to perform respective different control operations such as an engine control operation, an electric-motor control operation and a hydraulic-pressure control operation, as needed.

The electronic control apparatus 90 receives various input signals based on values detected by respective sensors provided in the vehicle 10. Specifically, the electronic control apparatus 90 receives: an output signal of an engine speed sensor 70 indicative of an engine rotational speed Ne that is a rotational speed of the engine 12; an output signal of an input speed sensor 71 indicative of the AT input rotational speed Ni; an output signal of an output speed sensor 72 indicative of the AT output rotational speed No corresponding to the vehicle running speed V; an output signal of an MG speed sensor 73 indicative of an MG rotational speed Nm that is a rotational speed of the electric motor MG; an output signal of a wheel speed sensor 74 indicative of a wheel speed Nr that is a rational speed of each of the front and rear wheels 14, 16; an output signal of an accelerator-opening degree sensor 75 indicative of an accelerator opening degree (accelerator operation degree) θacc representing an amount of accelerating operation made by the vehicle driver; an output signal of a throttle-opening degree sensor 76 indicative of a throttle opening degree 0th which is an opening degree of an electronic throttle valve; an output signal of a brake pedal sensor 77 indicative of the braking operation amount Bra and also a brake ON signal representing a state in which the brake pedal is being operated by the vehicle driver so as to operate the wheel brakes; an output signal of a G sensor 78 indicative of a longitudinal acceleration Gx and a lateral acceleration Gy of the vehicle 10; an output signal of a yaw rate sensor 79 indicative of a yaw rate Ryaw that is an angular acceleration of the vehicle 10 about its vertical axis; an output signal of a shift position sensor 80 indicative of a shift operation position POSsh that is an operation position of a shift lever 68 provided in the vehicle 10; an output signal of a towing-mode selection switch 81 indicative of a towing-mode ON signal representing a state in which a towing mode is selected by the vehicle driver; an output signal of a driving-state selection dial switch 82 indicative of a dial-switch operation position POSdl that is an operation position of driving-state selection dial switch 82; an output signal of a battery sensor 83 indicative of a battery temperature THbat, a battery charging/discharging electric current Ibat and a battery voltage Vbat of the battery 54; and an output signal of a fluid temperature sensor 84 indicative of a working-fluid temperature THoil that is a temperature of the working fluid OIL.

The shift lever 68 is a shift operation member for permitting the vehicle driver to manually select one of a plurality of shift positions in the power transmission apparatus 18, particularly, in the automatic transmission 24. The shift lever 68 is to be operated, by the vehicle driver, to be placed in the shift operation position POSsh corresponding to the selected one of the shift positions in the power transmission apparatus 18 or in the automatic transmission 24 (hereinafter simply referred to as “the shift positions in the automatic transmission 24”). The shift lever 68 is to be placed in one of a plurality of operation positions as the shift operation position POSsh, wherein the plurality of operation positions include P, R, N and D operation positions, for example.

The P operation position is for selecting a parking position (=P position) as one of the shift positions in the automatic transmission 24. When the P position is established in the automatic transmission 24, the automatic transmission 24 is placed in its neutral state and rotation of the transmission output shaft 48 is mechanically inhibited. The neutral state of the automatic transmission 24 is a state in which the drive power is not transmittable through the automatic transmission 24, and is realized by cutting off the power transmission through the automatic transmission 24, for example, with any one of the engagement devices CB being placed in the released state. The mechanical inhibition of rotation of the transmission output shaft 48 is made by a known parking lock mechanism provided in the vehicle 10. That is, the automatic transmission 24 is placed in its parking lock state, when the P position is established in the automatic transmission 24. The R operation position is a reverse-driving operation position for selecting a reverse driving position (=R position) as one of the shift positions in the automatic transmission 24. When the R position is established in the automatic transmission 24, the vehicle 10 is enabled to run in reverse direction. The N operation position is a neutral operation position for selecting a neutral position (=N position) as one of the shift positions in the automatic transmission 24. When the N position is established in the automatic transmission 24, the automatic transmission 24 is placed in the neutral state, so that the transmission output shaft 48 is not mechanically unrotatably fixed whereby the power transmission through the automatic transmission 24 is disabled. The D operation position is a forward-driving operation position for selecting a forward driving position (=D position) as one of the shift positions in the automatic transmission 24. When the D position is established in the automatic transmission 24, the vehicle 10 is enabled to run in forward direction with an automatic shift control being executed for the automatic transmission 24. That is, when the D position is established in the automatic transmission 24, the drive power causing the vehicle 10 to run in the forward direction can be transmitted through the automatic transmission 24.

The towing-mode selection switch 81 is disposed in the vicinity of a driver's seat, for example, and is a press button switch that is to be pressed by the vehicle driver, when a towed vehicle is to be towed by the vehicle 10. When the towing-mode selection switch 81 is operated by the vehicle driver, the towing mode is selected as one of driving modes. It is noted that the towing-mode selection switch 81 does not necessarily have to be the press button switch but may be a slide button or a seasaw button, for example.

The driving-state selection dial switch 82 is disposed in the vicinity of the driver's seat, for example, and is a dial switch that is to be operated by the vehicle driver for selecting a driving state of the vehicle 10. The driving-state selection dial switch 82 is to be placed in one of three operation positions consisting of “H-2WD”, “H-AWD” and “L-AWD”, for example. When the driving-state selection dial switch 82 is placed in “H-2WD”, a high-gear 2WD mode is selected as one of the driving modes. When the driving-state selection dial switch 82 is placed in “H-AWD”, a high-gear AWD mode is selected as one of the driving modes. When the driving-state selection dial switch 82 is placed in “L-AWD”, a low-gear AWD mode is selected as one of the driving modes. The high-gear 2WD mode is a driving mode in which the vehicle 10 is placed in the 2WD state as the driving state with the auxiliary transmission 106 of the transfer 26 being placed in the high gear position GSH. In the 2WD mode in which the drive power is distributed only to the rear wheels 16, the auxiliary transmission 106 is basically placed in the high gear position GSH. That is, in the present embodiment, the 2WD mode is the high-gear 2WD mode. The high-gear AWD mode is a driving mode in which the vehicle 10 is placed in the AWD state as the driving state with the auxiliary transmission 106 being placed in the high gear position GSH. The low-gear AWD mode is a driving mode in which the vehicle 10 is placed in the AWD state as the driving state with the auxiliary transmission 106 being placed in the low gear position GSL. In the present embodiment, an AWD mode (in which the drive power is distributed to the front wheels 14 as well as to the rear wheels 16) is categorized into the low-gear AWD mode and the high-gear AWD mode. It is noted that the driving-state selection dial switch 82 does not necessarily have to be the dial switch but my be a slide button or a seasaw button, for example.

The electronic control apparatus 90 generates various output signals to the various devices provided in the vehicle 10, such as: an engine control command signal Se that is to be supplied to the engine control device 50 for controlling the engine 12, an MG control command signal Sm that is to be supplied to the inverter 52 for controlling the electric motor MG; an ADD-switch control command signal Sadd that is to be supplied to the ADD-mechanism actuator 56 for switching a controlled state of the ADD mechanism 37; a CB hydraulic command signal Scb that is to be supplied to the hydraulic control unit 58 for controlling the engagement devices CB; a K0 hydraulic command signal Sk0 that is to be supplied to the hydraulic control unit 58 for controlling the K0 clutch 20; an EOP control command signal Seop that is to be supplied to the pump motor 64 for controlling operation of the EOP 62; a brake control command signal Sbra that is to be supplied to the wheel brake device 66 for controlling the brake torque TB of each of the wheel brakes; a high/low switching control signal Shl that is to be supplied to the shift actuator 126 for switching the auxiliary transmission 106 between the high gear position GSH and the low gear position GSL; and a driving-state switching control signal Swd that is to be supplied to the shift actuator 126 for controlling the transfer 26 so as to switch the vehicle 10 between the 2WD state and the AWD state.

For performing various control operations in the vehicle 10, the electronic control apparatus 90 includes a hybrid control means in the form of a hybrid control portion 92, a hydraulic-pressure control means in the form of a hydraulic-pressure control portion 94, and a driving mode control means in the form of a driving-mode control portion 96.

The hybrid control portion 92 has a function serving as an engine control means in the form of an engine control portion 92a for controlling operation of the engine 12 and a function serving as an electric-motor control means in the form of an electric-motor control portion 92b for controlling operation of the electric motor MG through the inverter 52, and executes a hybrid-drive control operation, for example, using the engine 12 and the electric motor MG through these control functions.

The hybrid control portion 92 calculates a requested drive amount of the vehicle 10 requested by the vehicle driver, by applying the accelerator opening degree θacc and the vehicle running speed V, for examples, to a requested drive amount map that represents a pre-stored relationship obtained by experimentation or determined by an appropriate design theory. The requested drive amount is, for example, a requested drive torque Trdem of the drive wheels (rear wheels 16 and front wheels 14). From another point of view, the requested drive torque Trdem [Nm] is a requested drive power Prdem [W] at the current vehicle running speed V. As the requested drive amount, another value such as a requested drive force Frdem [N] of the drive wheels 14 and a requested AT output torque of the transmission output shaft 48 may be used, too. In the calculation of the requested drive amount, it is also possible to use, for example, the AT output rotational speed No in place of the vehicle running speed V.

The hybrid control portion 92 outputs the engine control command signal Se and the MG control command signal Sm for controlling the engine 12 and the electric motor MG respectively, such that the requested drive power Prdem is realized, by taking account of various factors such as a transmission loss, an auxiliary load, the gear ratio γat of the automatic transmission 24 and a maximum chargeable amount Win and a maximum dischargeable amount Wout of the battery 54. The engine control command signal Se is, for example, a command value of an engine power Pe that is the power of the engine 12 outputting the engine torque Te at the current engine rotational speed Ne. The MG control command signal Sm is, for example, a command value of a consumed electric power Wm of the electric motor MG outputting the MG torque Tm at the current motor rotational speed Nm.

The maximum chargeable amount Win of the battery 54 is a maximum amount of the electric power that can be charged to the battery 54, and represents a limitation of the electric power inputted to the battery 54, namely, a limitation of input to the battery 54. The maximum dischargeable amount Wout of the battery 54 is a maximum amount of the electric power that can be discharged from the battery 54, and represents a limitation of the electric power outputted from the battery 54, namely, a limitation of output of the battery 54. The maximum chargeable and dischargeable amounts Win, Wout are calculated by the electronic control apparatus 90, for example, based on the battery temperature THbat and a state-of-charge value SOC [%] of the battery 54. The state-of-charge value SOC of the battery 54 is a value indicative of a charged state of the battery 54, i.e., an amount of the electric power stored in the battery 54, and is calculated by the electronic control apparatus 90, for example, based on the charging/discharging electric current Ibat and the voltage Vbat of the battery 54.

When the requested drive torque Trdem can be covered by only the output of the electric motor MG, the hybrid control portion 92 establishes a motor driving (=EV driving) mode as one of the driving modes. When the EV driving mode is established, the hybrid control portion 92 causes the vehicle 10 to perform an EV driving with the K0 clutch 20 being released and with only the electric motor MG serving as the drive power source. On the other hand, when the requested drive torque Trdem cannot be covered without at least the output of the engine 12, the hybrid control portion 92 establishes an engine driving mode, i.e., a hybrid driving (=HV driving) mode. When the HV driving mode is established, the hybrid control portion 92 causes the vehicle 10 to perform an engine driving, i.e., an HV driving with the K0 clutch 20 being engaged and with at least the engine 12 serving as the drive power source. Further, even when the requested drive torque Trdem can be covered by only the output of the electric motor MG, the hybrid control portion 92 establishes the HV driving mode, for example, in a case in which the state-of-charge value SOC of the battery 54 becomes less than a predetermined engine-start threshold value SOCengf or in a case in which the engine 12 or other component needs to be warmed up. The engine-start threshold value is a predetermined threshold value for determining that the state-of-charge value SOC reaches a level at which the engine 12 must forcibly be started for charging the battery 54. Thus, the hybrid control portion 92 switches between the EV driving mode and the HV driving mode, based on, for example, the requested drive torque Trdem, by automatically stopping the engine 12 during the HV driving, restarting the engine 12 after the stop of the engine 12, and starting the engine 12 during the EV driving.

The engine control portion 92a is configured to determine whether the starting of the engine 12 is requested (required) or not. The engine control portion 92a determines whether the starting of the engine 12 is requested or not, for example, depending on (i) whether the requested drive torque Trdem has become larger than a range that can be covered by only the output of the electric motor MG (ii) whether the engine 12 or other component needs to be warmed up and (iii) whether the state-of-charge value SOC of the battery 57 has become less than the engine-start threshold value SOCengf.

When it is determined by the engine control portion 92a that the starting of the engine 12 is requested, the hydraulic-pressure control portion 94 outputs the K0 hydraulic command signal Sk0 that is supplied to the hydraulic control unit 58, wherein the hydraulic command signal Sk0 requests the K0 clutch 20 to be switched from the released state to the engaged state, for thereby obtaining the K0 torque Tk0 that enables transmission of a torque required for cranking of the engine 12, i.e., a torque by which the engine rotational speed Ne to be increased. In the following description of the present embodiment, the torque required for cranking of the engine 12 will be referred to as “required cranking torque Tcrn”.

When it is determined by the engine control portion 92a that the starting of the engine 12 is requested, the electric-motor control portion 92b outputs the MG control command signal Sm that is supplied to the inverter 52, wherein the MG control command signal Sm requests the electric motor MG to output the required cranking torque Tcrn concurrently with switching of the K0 clutch 20 from the released state to the engaged state by the hydraulic-pressure control portion 94.

When determining that the starting of the engine 12 is requested, the engine control portion 92a outputs the engine control command signal Se that is supplied to the engine control device 50, wherein the engine control command signal Se requests fuel supply and engine ignition to be initiated in conjunction with the cranking of the engine 12 that is made by the K0 clutch 20 and the electric motor MG.

When the engine 12 is to be started during the EV driving, the electric-motor control portion 92b causes the electric motor MG to output the MG torque Tm corresponding to the required cranking torque Tcrn, in addition to the MG torque Tm for the EV driving, i.e., the MG torque Tm serving as the drive torque Tr. To this end, during the EV driving, the required cranking torque Tcrn needs to be available or assured in preparation for starting the engine 12. Therefore, when the engine 12 is to be started, the requested drive torque Trdem can be covered by only the output of the electric motor MG when the requested drive torque Trdem is not larger than a torque value obtained by subtracting the required cranking torque Tcrn from an outputtable maximum torque of the electric motor MG The outputtable maximum torque of the electric motor MG is an outputtable maximum value of the motor torque Tm which is dependent on the maximum dischargeable amount Wout of the battery 54.

The engine control portion 92a makes a determination as to whether the stop of the engine 12 is requested or not. This determination is made by the engine control portion 92a during the HV driving mode, depending on, for example, (i) whether the requested drive torque Trdem can be covered by only the output of the electric motor MG, (ii) whether the engine 12 or other components are unrequired to be warmed, and (iii) whether the state-of-charge value SOC of the battery 54 is at least the engine-start threshold value SOCengf.

When determining that the stop of the engine 12 is requested, the engine control portion 92a supplies, to the engine control device 50, the engine control command signal Se requesting stop of the fuel supply to the engine 12. That is, when the engine 12 is to be stopped, the engine control portion 92a supplies, to the engine control device 50, the engine control command signal Se by which the engine 12 is to be controlled to be stopped.

When it is determined by the engine control portion 92a that the stop of the engine 12 is requested, the hydraulic-pressure control portion 94 supplies, to the hydraulic control unit 58, the K0 hydraulic command signal Sk0 by which the K0 clutch 20 is to be controlled to be switched from the engaged state to the released state.

Thus, the engine control portion 92a controls the operation state of the engine 12, in accordance with an engine operation condition REQeng for starting and stopping the engine 12. The engine operation condition REQeng defines threshold values such as a predetermined drive power Prf and the above-described engine-start threshold value SOCengf. The requested drive power Prdem can be covered by only the output of the electric motor MG when the requested drive power Prdem is larger than the predetermined drive power Prf. The battery 54 needs to be charged when the state-of-charge value SOC of the battery 54 is less than the engine-start threshold value SOCengf.

The hydraulic-pressure control portion 94 determines whether a shifting action is to be executed in the automatic transmission 24, by using, for example, a shifting map that represents a predetermined relationship, and outputs the CB hydraulic command signal Scb, as needed, which is supplied to the hydraulic control unit 58, for executing the shifting action in the automatic transmission 24. In the shifting map, the predetermined relationship is represented by shifting lines in two-dimensional coordinates in which the vehicle running speed V and the requested drive torque Trdem as two variables are taken along respective two axes, wherein the shifting lines are used for the determination as to whether the shifting action is to be executed in the automatic transmission 24. In the shifting map, one of the two variables may be the AT output rotational speed No in place of the vehicle running speed V, and the other of the two variables may be any one of the requested drive force Frdem, accelerator opening degree θacc and throttle opening degree θth in place of the requested drive torque Trdem.

The driving-mode control portion 96 controls running of the vehicle 10 so as to realize selected at least one of the driving modes which is selected by the vehicle driver. Specifically, the driving modes include the towing mode, the 2WD mode (i.e., high-gear 2WD mode) and the AWD mode, wherein the AWD mode is categorized into the high-gear AWD mode and the low-gear AWD mode.

When the towing mode is selected by the towing-mode selection switch 81, the driving-mode control portion 96 supplies, to the hydraulic-pressure control portion 94, a command requesting a shift control to be executed in the automatic transmission 24 in accordance with a shifting map by which a lower gear position (providing a higher gear ratio) could be established in the automatic transmission 24 than when the towing mode is not selected.

When the high-gear 2WD mode is selected by the driving-state selection dial switch 82, the driving-mode control portion 96 outputs the high/low switching control signal Shl and the driving-state switching control signal Swd that are supplied to the shift actuator 126, and also outputs the ADD-switch control command signal Sadd that is supplied to the ADD-mechanism actuator 56, wherein the high/low switching control signal Shl requests the high gear position GSH to be established in the auxiliary transmission 106, the driving-state switching control signal Swd requests the power-distribution dog clutch 108 to be placed in the released state, and the ADD-switch control command signal Sadd requests the ADD mechanism 37 to be placed in the released state.

When the high-gear AWD mode is selected by the driving-state selection dial switch 82, the driving-mode control portion 96 outputs the high/low switching control signal Shl and the driving-state switching control signal Swd that are supplied to the shift actuator 126, and also outputs the ADD-switch control command signal Sadd that is supplied to the ADD-mechanism actuator 56, wherein the high/low switching control signal Shl requests the high gear position GSH to be established in the auxiliary transmission 106, the driving-state switching control signal Swd requests the power-distribution dog clutch 108 to be placed in the engaged state, and the ADD-switch control command signal Sadd requests the ADD mechanism 37 to be placed in the engaged state.

When the low-gear AWD mode is selected by the driving-state selection dial switch 82, the driving-mode control portion 96 outputs the high/low switching control signal Shl and the driving-state switching control signal Swd that are supplied to the shift actuator 126, and also outputs the ADD-switch control command signal Sadd that is supplied to the ADD-mechanism actuator 56, wherein the high/low switching control signal Shl requests the low gear position GSL to be established in the auxiliary transmission 106, the driving-state switching control signal Swd requests the power-distribution dog clutch 108 to be placed in the engaged state, and the ADD-switch control command signal Sadd requests the ADD mechanism 37 to be placed in the engaged state.

When the towing mode and/or the AWD mode is selected, a larger drive force Fr is likely to be required, than when a normal mode is established, wherein the normal mode is a mode in which the 2WD mode is selected with the towing mode being not selected. In the HV driving mode in which the engine 12 is in its operated state, a larger drive force Fr is available easier than in the EVdriving mode. Therefore, the engine operation condition REQeng is determined such an engine operation ratio Reng is higher when the towing mode and/or the AWD mode is selected, than when the normal mode is established, wherein the engine operation ratio Reng is a ratio of an operation time of the engine 12 to an operation time of the vehicle 10. The operation time of the vehicle 10 is a time for which a main power-supply switch of the vehicle 10 is placed in its ON state, and corresponds to a sum of the operation time of the engine 12 and a stop time of the engine 12. The operation time of the vehicle 10 may be referred also to as “power-ON time of the vehicle 10”. The operation time of the engine 12 is a time for which the engine 12 is in its operated state during the operation time of the vehicle 10. The stop time of the engine 12 is a time for which the engine 12 is in its stopped state during the operation time of the vehicle 10.

The engine operation condition REQeng defines the predetermined drive power Prf and the engine-start threshold value SOCengf, such that the predetermined drive power Prf is set to a smaller value when the towing mode and/or the AWD mode is selected, than when the normal mode is established, and such that the engine-start threshold value SOCengf is set to a larger value than when the towing mode and/or the AWD mode is selected, than when the normal mode is established.

In the normal mode, the EV driving mode and the HV driving mode are alternately switched to each other by execution of an engine intermittent operation in which the engine 12 is placed alternately in an operated state and a stopped state. In view of a responsiveness when a large drive force Fr is required, it is desirable that, when the engine 12 has been placed in the operated state, the engine intermittent operation is inhibited so as not to switch the engine 12 from the operated state to the stopped state. Therefore, the engine operation condition REQeng includes an engine intermittent-operation condition that is determined, such that the engine intermittent operation is inhibited in a case in which the towing mode and/or the AWD mode is selected, and is allowed in a case in which the normal mode is established.

By the way, a large drive force Fr is necessarily required in the towing mode when the vehicle 10 is to start running or is to be accelerated. On the other hand, in the AWD mode, there is a case in which a large drive force Fr is not necessarily required. It is therefore possible to improve an energy efficiency, by placing the engine 12 in the operated state as needed. To this end, the engine operation condition REQeng is determined such that the engine operation ratio is higher in a case in which at least the towing mode is selected, than in a case in which the AWD mode is selected without the towing mode being selected. That is, the engine operation condition REQeng is determined such that engine 12 is placed in the stopped state more frequently in the case in which the AWD mode is selected without the towing mode being selected, than in the case in which at least the towing mode is selected.

It is desirable that the engine 12 is started in an earlier stage so as to securely secure a required drive force Fr in the towing mode as compared with in the AWD mode. To this end, the engine operation condition REQeng includes an engine start condition that is determined such that the starting of the engine 12 is initiated at a point of time at which the towing mode is selected in a case in which the towing mode is selected when the vehicle 10 is in a predetermined state STvf. That is, in the case in which the towing mode is selected when the vehicle 10 is in the predetermined state STvf, the predetermined drive power Prf and the engine-start threshold value SOCengf are abolished, so that the HV driving mode is established irrespective of the requested drive power Prdem and the state-of-charge value SOC of the battery 54. Further, the engine start condition is determined such that, in a case in which the AWD mode is selected without the towing mode being selected when the vehicle 10 is in the predetermined state STvf, the starting of the engine 12 is initiated at a point of time at which a predetermined request REQvf is made in the vehicle 10 after the AWD mode is selected.

In the towing mode, a large drive force Fr is necessarily required when the vehicle is to start running. Therefore, the above-described predetermined state STvf is, for example, a state in which the vehicle 10 is stopped with the automatic transmission 24 being placed in the D position or N position. In the AWD mode in which the engine 12 is not started until the predetermined request REQvf is made, the predetermined state STvf may be a state in which the automatic transmission 24 is placed not only in the D position or N position but also in the R position or P position.

The above-described predetermined request REQvf is, for example, an acceleration request that increases the drive force Fr or a request for charging the battery 54. The acceleration request that increases the drive force Fr is, for example, an increase of the requested drive force Frdem, due to the accelerating operation. The request for charging the battery 54 is made, for example, when the state-of-charge value SOC of the battery 54 has been reduced to be smaller than the engine-start threshold value SOCengf. In the AWD mode, where the predetermined state STvf is a state in which the automatic transmission 24 is placed in the P position, the predetermined request REQvf may be requested when the shift lever 68 is placed from the P operation position to the D operation position or R operation position. Similarly, in the AWD mode, where the predetermined state STvf is a state in which the automatic transmission 24 is placed in the N position, the predetermined request REQvf may be requested when the shift lever 68 is placed from the N operation position to the D operation position or R operation position.

For switching between the low-gear AWD mode and the high-gear AWD mode, the auxiliary-transmission dog clutch 120 of the auxiliary transmission 106 requires to be switched. For switching the auxiliary-transmission dog clutch 120, the input shaft 102 and other rotary members are required to be rotated. For switching between the low-gear AWD mode and the high-gear AWD mode, the engine 12 is required to be in the operated state, or alternatively, the electric motor MG is required to be rotated. In the AWD mode in which the engine 12 is not started until the predetermined request REQvf is made, the electric motor MG is placed into its rotated state in a case in which the engine 12 is in its stopped state when the AWD mode is selected. For example, when the high-gear 2WD mode is to be switched to the high-gear AWD mode, the switching of the auxiliary-transmission dog clutch 120 is not required, but the electric motor MG is placed into the rotated state in preparation for the switching from the high-gear AWD mode to the low-gear AWD mode which requires the switching of the auxiliary-transmission dog clutch 120.

In a case in which the high-gear 2WD mode is switched to the high-gear AWD mode in a response to selection of the high-gear AWD mode during the high-gear 2WD mode with each of the engine 12 and the electric motor MG being in the stopped state, for example, the electric-motor control portion 92b executes an MG idling control for idling the electric motor MG with the engine 12 being held in the stopped state. The MG idling control is a control for placing the electric motor MG into an idle state in which the MG rotational speed Nm is kept at an MG idle speed that is a predetermined idling rotational speed of the electric motor MG In the MG idling control, the electric motor MG is controlled to output a predetermined torque causing a creep phenomenon in which the vehicle 10 is moved slowly with the accelerator being kept OFF, upon release of the brake pedal during a temporary stop of the vehicle 10 when the engine 12 is in the stopped state with the accelerator being OFF. The predetermined torque is a creep toque that causes the vehicle 10 to perform a so-called creep running, for example, when the brake pedal is released with the accelerator being kept OFF during the stopped state of the vehicle 10.

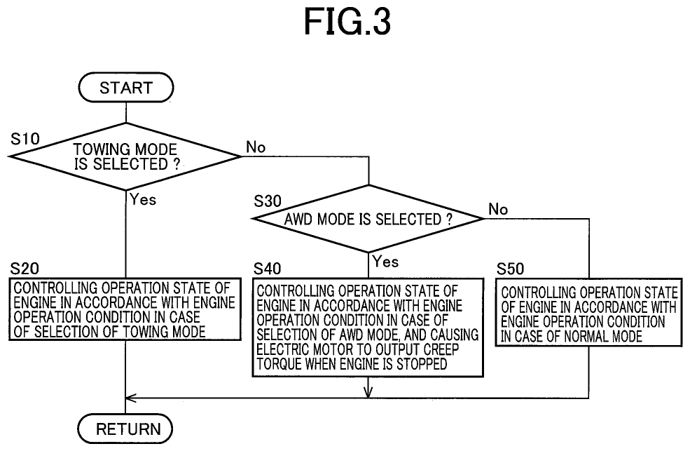

FIG. 3 is a flow chart showing a main part of a control routine executed by the electronic control apparatus 90, namely, a control routine that is executed for suppressing reduction of drivability of the vehicle 10 and improving an energy efficiency. This control routine is executed, for example, in a repeated manner.

As shown in FIG. 3, this control routine is initiated with step S10 corresponding to function of the driving-mode control portion 96, which is implemented to determine whether the towing mode is selected or not. When an affirmative determination is made at step S10, step S20 corresponding to function of the engine control portion 92a is implemented to control the operation state of the engine 12 in accordance with the engine operation condition REQeng in case of selection of the towing mode. When a negative determination is made at step S10, step S30 corresponding to function of the driving-mode control portion 96 is implemented to determine whether the AWD mode is selected or not. When an affirmative determination is made at step S30, step S40 corresponding to functions of the engine control portion 92a and the electric-motor control portion 92b is implemented to control the operation state of the engine 12 in accordance with the engine operation condition REQeng in case of selection of the AWD mode. At this step S40, in a case in which the vehicle 10 is stopped with the engine 12 being in the stopped state, the creep torque is outputted by the electric motor MG When a negative determination is made at step S30, step S50 corresponding to function of the engine control portion 92a is implemented to control the operation state of the engine 12 in accordance with the engine operation condition REQen in case of the normal mode.

As described above, in the present embodiment, the engine operation condition REQeng is determined such that the engine operation ratio Reng of the engine 12 is higher in the case in which the towing mode is selected, than in the case in which the AWD mode is selected without the towing mode being selected. This control arrangement makes it possible to easily secure the sufficient drive force Frin the case in which the towing mode is selected, and to easily improve the energy efficiency in the case in which the AWD mode is selected without the towing mode being selected. That is, the engine 12 is started and stopped in manners that vary depending on whether the towing mode or the AWD mode is selected, wherein the towing mode is a mode in which the large drive force Fr is necessarily required when the vehicle 10 is to start running and is to be accelerated, while the AWD mode is a mode in which the large drive force Fr is not necessarily required. It is therefore possible to suppress reduction of the drivability of the vehicle 10 and improve the energy efficiency.

In the present embodiment, the engine operation condition REQeng is determined such that the engine operation ratio Reng of the engine 12 is higher in the case in which the towing mode or the AWD mode is selected, than in the case in which the 2WD mode is selected without the towing mode being selected, so that the required drive force Fr is easily secured not only when the towing mode is selected but also when the AWD mode is selected.

In the present embodiment, the engine operation condition REQeng includes the engine intermittent-operation condition that is determined, such that the engine intermittent operation is inhibited in the case in which the towing mode or the AWD mode is selected, and such that the engine intermittent operation is allowed in the case in which the 2WD mode is selected without the towing mode being selected, so that the required drive force Fr is further easily secured not only when the towing mode is selected but also when the AWD mode is selected.

In the present embodiment, the engine operation condition REQeng includes the engine start condition that is determined, such that, in the case in which the towing mode is selected when the vehicle 10 is in the predetermined state STvf, the starting of the engine 12 is initiated at the point of time at which the towing mode is selected, and such that, in the case in which the AWD mode is selected without the towing mode being selected when the vehicle 10 is in the predetermined state STvf, the starting of the engine 12 is initiated at the point of time at which the predetermined request REQvf is made in the vehicle 10 after the AWD mode is selected, so that the sufficient drive force Fr is easily secured when the vehicle 10 is to start running and is to be accelerated in the case in which the towing mode is selected, and the energy efficiency is easily improved in the case in which the AWD mode is selected.

In the present embodiment, the predetermined state STvf is (i) the state in which the vehicle 10 is stopped with the automatic transmission 24 being placed in the D position or (ii) the state in which the vehicle 10 is stopped with the automatic transmission 24 being placed in the N position, and the predetermined request REQvf is (iii) the request of the acceleration of the vehicle 10 or (iv) the request of the charge of the battery 54, so that the sufficient drive force Fr is easily secured when the vehicle 10 is to start running in the case in which the towing mode is selected, and the energy efficiency is easily improved in the case in which the AWD mode is selected.

In the present embodiment, the electric motor MG is caused to output the creep torque in the state in which the engine 12 is held in the stopped state, in the case in which the high-gear 2WD mode is switched to the high-gear AWD mode with the high-gear AWD mode being selected in the high-gear 2WD mode when each of the engine 12 and the electric motor MG is in the stopped state, so that it is possible to easily obtain the rotation required by the operation of the auxiliary-transmission dog clutch 120 in the auxiliary transmission 106 in the high-gear AWD mode. Owing to this control arrangement, the switching to the low-gear AWD mode can be reliably made even when the engine 12 is placed in the stopped state after the high-gear 2WD mode is switched to the high-gear AWD mode.

There will be described other embodiments of this invention. The same reference signs as used in the above-described first embodiment will be used in the following embodiments, to identify the functionally corresponding elements, and descriptions thereof are not provided.

### Second Embodiment

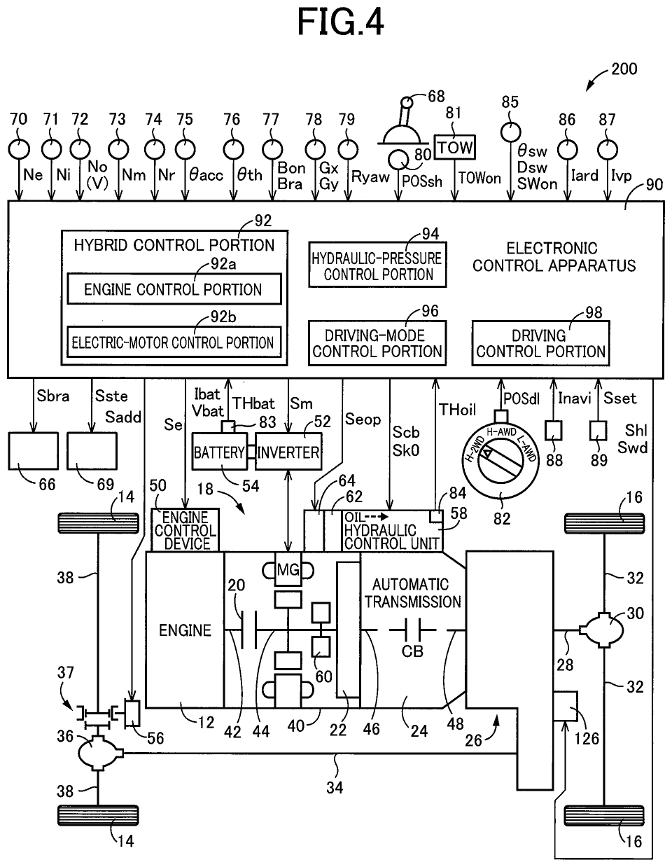

FIG. 4 is a view schematically showing a construction of a vehicle 200 to which the present invention is applied, for explaining major portions of control functions and control systems that are provided to perform various control operations in the vehicle 200, in an embodiment other than the above-described first embodiment shown in FIG. 1. The vehicle 200 shown in FIG. 4 is a hybrid electric vehicle as the vehicle 10 in the first embodiment. The vehicle 200 is different from the vehicle 10 mainly in that a steering device 69, a steering sensor 85, a vehicle-area information sensor 86, a vehicle location sensor 87, a navigation system 88 and various kinds of setting switches 89 are provided in the vehicle 200 and in that a driving control portion 98 is provided in the electronic control apparatus 90. There will be described mainly the differences from the vehicle 10.

The vehicle control apparatus 90 receives various input signals based on values detected by respective sensors provided in the vehicle 200. Specifically, the vehicle control apparatus 90 receives: an output signal of the steering sensor 85 indicative of a steering angle θsw and a steering direction Dsw of a steering wheel provided in the vehicle 200 and also a steering ON signal SWon representing a state in which the steering wheel is being held by the vehicle driver; an output signal of the vehicle-area information sensor 86 indicative of vehicle area information lard; an output signal of the vehicle location sensor 87 indicative of location information Ivp; an output signal of the navigation system 88 indicative of navigation information Inavi; and output signals of the setting switches 89 indicative of setting signals Sset representing a setting made by the vehicle driver for executions of various controls.

The vehicle-area information sensor 86 includes a lidar, a radar and/or the onboard camera, for example, so as to directly obtain information related to a road on which the vehicle 200 is running and information related to an object or objects present around the vehicle 200. For example, the vehicle-area information sensor 86 is configured to detect objects present in the respective front, lateral and rear sides of the vehicle 200, and to output, as the vehicle area information lard, object information that is information related to the detected object or objects, wherein the object information outputted includes a distance and a direction of each of the detected objects from the vehicle 200.

The vehicle location sensor 87 includes a GPS antenna. The location information Ivp outputted by the vehicle location sensor 87 includes own-vehicle location information indicating a location of the vehicle 200 on the earth's surface or a map based on, for example, GPS signals (Orbit Signals) transmitted by GPS (Global Positioning System) satellites.

The navigation system 88 is a known navigation system including a display and a speaker, and is configured to specify a location of the vehicle 200 on pre-stored map data, based on the location information Ivp. The navigation system 88 receives a destination point inputted thereto, calculates a driving route from a departure point to the destination point, and informs, as instructions, the vehicle driver of the driving route, for example, through the display and the speaker. The navigation information Inavi includes map information such as road information and facility information that are based on the map data pre-stored in the navigation system 88.

The setting switches 89 include an automatic-drive selecting switch for executing an automatic drive control CTad, a cruise switch for executing a cruise control CTcr, a switch for setting the vehicle running speed in execution of the cruise control CTcr, a switch for setting a distance from another vehicle preceding the vehicle 200 in execution of the cruise control CTcr, and a switch for executing a lane keeping control for keeping the vehicle 200 to run within a selected road lane.

The setting switches 89 include an EV driving switch for executing a control in which the EV driving mode is more continued as compared with switching between the EV driving mode and the HV driving mode which is made depending on determination by engine control portion 92a as to whether the starting of the engine 12 is requested or not. A normal mode, which is executed when the EV driving switch is not operated, is a charge-amount sustaining mode that enables the EV driving to be performed with only the electric motor MG serving as the drive power source when the engine 12 subjected to the engine intermittent operation is placed in the stopped state. The charge-amount sustaining mode is a CS (Charge Sustaining) mode in which the vehicle 200 runs with the state-of-charge value SOC of the battery 54 being kept at its target value. A driving mode in which the EV driving mode is continued is a mode that enables the EV driving even when the state-of-charge value SOC of the battery 54 becomes smaller than the engine-start threshold value SOCengf, and is a charge-amount consuming mode in which the EV driving can be continued more than in the charge-amount sustaining mode. The charge-amount consuming mode is a CD (Charge Depleting) mode in which the vehicle 200 runs while reducing the state-of-charge value SOC of the battery 54. Thus, the driving modes include the charge-amount sustaining mode and the charge-amount consuming mode. When the EV driving switch is operated, the driving-mode control portion 96 outputs a command that is supplied to the hybrid control portion 92, for example, wherein the command requests the charge-amount consuming mode to be established.

In the present second embodiment, the shift lever 68 is to be placed in one of a plurality of operation positions as the shift operation position POSsh, wherein the plurality of operation positions include a B operation position in addition to the above-described P, R, N and D operation positions. The B operation position is an engine-brake operation position by which an engine brake mode is selected as the driving mode, wherein the engine brake mode is a driving mode in which an engine brake torque TBe is to be generated during deceleration running of the vehicle 200 with the automatic transmission 24 being placed in the D position.

The brake torque TB applied to the vehicle 200 is constituted by, for example, a regenerative brake torque TBr and a wheel brake torque TBw in addition to the engine brake torque TBe. The regenerative brake torque TBr is a brake torque obtained by a regenerative brake of the electric motor MG A regenerative control by which the electric motor MG is to be regenerated is a control executed for driving and rotating the electric motor MG by a driven torque that is to be transmitted from the rear wheels 16, for example, so that the battery 54 is charged through the inverter with an electric power generated by the electric motor MG serving as a generator. The wheel brake torque TBw is a brake torque obtained by the wheel brakes of the wheel brake device 66. The engine brake torque TBe is a brake torque obtained by an engine brake generated by a rotational resistance such as a pumping loss and a friction torque that are caused in rotation of the engine 12 driven by the driven torque.

In the brake torque TB applied to the vehicle 200, the regenerative brake torque TBr is preferentially generated, for example, from a viewpoint of improving the energy efficiency. The hybrid control portion 92 outputs the MG control command signal Sm supplied to the inverter 52, wherein the MG control command signal Sm requests the regenerative control of the electric motor MG to be executed for obtaining the regenerative toque required for the regenerative brake torque TBr. The hybrid control portion 92 replaces the regenerative brake torque TBr by the wheel brake torque TBw, for example, shortly before the vehicle 200 stops, so that the brake torque TB applied to the vehicle 200 is constituted mainly by the wheel brake torque TBw in a stage shortly before the vehicle 200 stops. In this instance, the hybrid control portion 92 outputs the brake control command signal Sbra that is supplied to the wheel brake device 66, wherein the brake control command signal Sbra requests generation of the required wheel brake torque TBw.

When the engine brake mode is selected as one of the driving modes with the shift operation position POSsh being the B operation position, the driving-mode control portion 96 outputs a command that is supplied to the hybrid control portion 92 and the hydraulic-pressure control portion 94, wherein the command requests the engine brake torque TBe to be generated in addition to or in place of the regenerative brake torque TBr, with the K0 clutch 20 being placed in the engaged state or slipping state, during deceleration running of the vehicle 200. When the shift operation position POSsh is not the B operation position, the regenerative brake mode is selected as one of the driving modes whereby the regenerative brake torque TBr rather than the engine brake torque TBe is preferentially generated during deceleration running of the vehicle 200. Thus, the driving modes include the engine brake mode and the regenerative brake mode.

The electronic control apparatus 90 outputs various command signals such as a steering control command signal Sste, which are supplied to various devices (such as the steering device 69) provided in the vehicle 200, wherein the steering control command signal Sste is provided for controlling steering of the wheels (particularly, the front wheels 14).

The steering device 69 is configured to apply an assist torque to a steering system of the vehicle 200, wherein a magnitude of the assist torque is dependent on, for example, the vehicle running speed V, steering angle θsw, steering direction Dsw and yaw rate Ryaw. For example, during the automatic drive control CTad, the steering device 69 applies, to the steering system of the vehicle 200, the torque controlling steering of the front wheels 14.

For performing various control operations in the vehicle 200, the electronic control apparatus 90 further includes a driving control means in the form of the driving control portion 98.

The requested drive amount of the vehicle 200 is a requested drive amount of the vehicle 200 requested by the vehicle driver, for example, during execution of a manual drive control CTmd, and is a requested drive amount of the vehicle 200 requested by a drive assist control CTsd, for example, during execution of the drive assist control CTsd.

During execution of the manual drive control CTmd, for example, the hybrid control portion 92 calculates a driver requested drive force Frdemd that is the requested drive amount of the vehicle 200 requested by the vehicle driver, by applying the accelerator opening degree θacc and the vehicle running speed Vto the requested drive amount map. During execution of the drive assist control CTsd, for example, the hybrid control portion 92 calculates a system requested drive force Frdems that is the requested drive amount of the vehicle 200 requested by the drive assist control CTsd. It is noted that the requested drive force Frdem, the requested drive torque Trdem, the requested drive power Prdem and other corresponding values can be converted into one another.

The driving control portion 98 is capable of executing, as a control for driving the vehicle 200, the manual drive control CTmd and the drive assist control CTsd, wherein the manual drive control CTmd is to be executed for driving the vehicle 200 in accordance with driving operations made by the vehicle driver, and the drive assist control CTsd is to be executed for driving the vehicle 200 by automatically performing acceleration/deceleration, braking, and/or steering, regardless of the driving operations made by the vehicle driver.

The manual drive control CTmd is a drive control by which the vehicle 200 is caused to run by manual driving operations that are the diving operations made by the vehicle driver. The manual driving operations include the accelerating operation for accelerating and decelerating the vehicle 200, the braking operation for controlling the brake applied to the vehicle 200, the steering operation for operating the steering wheel and other operations made by the vehicle driver so as to cause the vehicle 200 to run in a normal manner.

The drive assist control CTsd is a drive control by which the vehicle 200 is caused to run, for example, with a drive assist by which a part or all of the driving operations made by the vehicle driver are automatically assisted. The drive assist is a method of driving the vehicle 200 by automatically controlling the acceleration/deceleration, braking, and/or steering, through the electronic control apparatus 90, based on the signals and information supplied from the various sensors, regardless of the driving operations made by the vehicle driver. The drive assist control CTsd is, for example, an automatic drive control CTad in which the vehicle 200 is automatically accelerated, decelerated, braked and steered, depending on a target driving state that is automatically determined based on, for example, the map information and the destination point inputted by the vehicle driver. Alternatively, the drive assist control CTsd is an automatic running speed control CTas for controlling the vehicle running speed V, for example, regardless of the accelerator opening degree θacc. The automatic running speed control CTas is a known cruise control CTcr in which, for example, some of the driving operations such as the steering operation are executed by the vehicle driver while the other driving operations such as the accelerating, decelerating and braking operations are automatically executed. Alternatively, the automatic running speed control CTas is a known automatic speed limiting control (ASL (Adjustable Speed Limiter)) in which, for example, the drive force Fr is controlled such that the running speed V does not exceed a target speed value that is set by the vehicle driver.

When a drive-assist mode is not selected with the automatic-drive selecting switch and the cruise switch of the setting switches 89 being placed in OFF, the driving control portion 98 establishes a manual drive mode so as to execute the manual drive control CTmd. In this instance, the driving control portion 98 executes the manual drive control CTmd, for example, by outputting commands that are supplied to the hybrid control portion 92 and the hydraulic-pressure control portion 94, wherein the commands request the engine 12, electric motor MG and automatic transmission 24 to be controlled in accordance with the driving operations made by the vehicle driver.

When the automatic drive is selected with the automatic-drive selecting switch of the setting switches 89 being operated by the vehicle driver, the driving control portion 98 establishes an automatic drive mode so as to execute the automatic drive control CTad. Specifically, a target driving state is automatically determined by the driving control portion 98, based on, for example, the destination point inputted by the vehicle driver, the own-vehicle location information based on the location information Ivp, the map information based on the navigation information Inavi and various information related to a driving route based on the vehicle area information lard. The driving control portion 98 executes the automatic drive control CTad by outputting commands that are supplied to the hybrid control portion 92 and the hydraulic-pressure control portion 94, wherein the commands request the engine 12, electric motor MG and automatic transmission 24 to be controlled whereby the acceleration/deceleration, braking and steering are automatically performed based on the determined target driving state. In addition to the commands supplied to the hybrid control portion 92 and the hydraulic-pressure control portion 94, the driving control portion 98 outputs the brake control command signal Sbra that is supplied to the wheel brake device 66 for obtaining the required brake torque, and the steering control command signal Sste that is supplied to the steering device 69 for controlling the steering of the front wheels, so as to execute the automatic drive control CTad.

In the above-described first embodiment, there has been described, by way of example, the control by which the engine operation condition REQeng is changed depending on whether the towing mode is selected or not, such that the engine operation condition REQeng in the case in which the towing mode is selected is different from the engine operation condition REQeng in the case in which the AWD mode is selected without the towing mode being selected. Where the towing mode is categorized into a plurality of kinds of towing modes, it is possible to execute also a control by which the engine operation condition REQeng is varied depending on which one of the plurality of kinds of towing modes is selected.

Specifically, in the present second embodiment, the towing mode, which is one of the driving modes, is categorized into a first towing mode and a second towing mode which are different from each other. That is, in this second embodiment, the driving modes include the first towing mode and the second towing mode, and the engine operation condition REQeng is determined such that the engine operation condition REQeng is higher in a case in which the first towing mode is selected, than in a case in which the second towing mode is selected.

It is desirable that the engine 12 is started in an earlier stage so as to securely secure the required drive force Fr in the first towing mode as compared with in the second towing mode. To this end, the engine operation condition REQeng includes an engine start condition that is determined such that the starting of the engine 12 is initiated at a point of time at which the first towing mode is selected in a case in which the first towing mode is selected when the vehicle 200 is in the predetermined state STvf. Further, the engine start condition is determined such that, in a case in which the second towing mode is selected when the vehicle 200 is in the predetermined state STvf, the starting of the engine 12 is initiated at a point of time at which the predetermined request REQvf is made in the vehicle 200 after the second towing mode is selected. The predetermined request REQvf is, for example, the acceleration request that increases the drive force, which is made, for example, when the driver requested drive force Frdemd or the system requested drive force Frdems is increased.

When a total weight of the towed vehicle is light, a large drive force Fr is not necessarily required, as compared with when the total weight is heavy. Therefore, the second towing mode is to be selected when the total weight of the towed vehicle is relatively light, and the first towing mode is to be selected when the total weight is relatively heavy. The towing-mode selection switch 81 may include a light-weight towing-mode selection switch and a heavy-weight towing-mode selection switch, such that one of the first and second towing modes is selected when a corresponding one of the light-weight towing-mode selection switch and the heavy-weight towing-mode selection switch is operated by the vehicle driver. Alternatively, when the towing-mode selection switch 81 is operated by the vehicle driver, one of the first and second towing modes may be automatically selected by the electronic control apparatus 90, for example, depending on the accelerator opening degree θacc and the longitudinal acceleration Gx.

The system requested drive force Frdems tends to have a higher degree of freedom during execution of the drive assist control CTsd than during execution of the manual drive control CTmd. Further, a reduction of an acceleration responsiveness is unlikely to be problematic during execution of the drive assist control CTsd as compared with during execution of the manual drive control CTmd. Therefore, the first towing mode is a towing mode to be selected when the manual drive control CTmd is executed, while the second towing mode is a towing mode to be selected when the drive assist control CTsd is executed.

The charge-amount sustaining mode is a driving mode in which both of the power performance and the energy efficiency are achieved by switching between the EV driving mode and the HV driving mode. On the other hand, the charge-amount consuming mode is a driving mode that makes it easier for the EV driving to be continued as compared with the charge-amount sustaining mode, and is a driving mode that prioritizes improvement of the energy efficiency rather than the power performance. Therefore, the first towing mode is a towing mode to be selected when the charge-amount sustaining mode is executed, while the second towing mode is a towing mode to be selected when the charge-amount consuming mode is executed.

In the engine brake mode, the engine 12 requires to be held in its rotated state, although a large brake torque TB is easily obtained owing to the engine brake torque TBe, as compared with in the regenerative brake mode. On the other hand, in the regenerative brake mode in which the engine brake torque TBe is not generated, the energy efficiency can be improved. Therefore, the first towing mode is a towing mode to be selected when the engine brake mode is selected, while the second towing mode is a towing mode to be selected when the regenerative brake mode is selected.

When the AWD mode is selected, a larger drive force Fr is likely to be required as compared with when the 2WD mode is selected. On the other hand, when the 2WD mode is selected, there is a case in which a large drive force Fr is not necessarily required. Therefore, the first towing mode is a towing mode to be selected when the AWD mode is executed, while the second towing mode is a towing mode to be selected when the 2WD mode is executed.

As described above, basically, the first towing mode is a towing mode in which the power performance is important, while the second towing mode is a towing mode in which the energy efficiency is important.

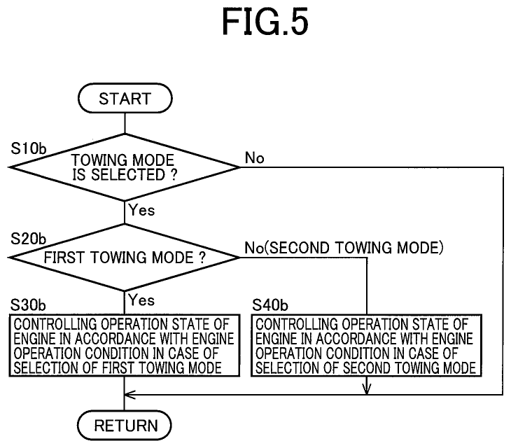

FIG. 5 is a flow chart showing a main part of a control routine executed by the electronic control apparatus 90, namely, a control routine that is executed for suppressing reduction of the drivability of the vehicle and improving the energy efficiency, wherein the control routine is different from that shown in FIG. 3. This control routine is executed, for example, in a repeated manner.

As shown in FIG. 5, this control routine is initiated with step S10b corresponding to function of the driving-mode control portion 96, which is implemented to determine whether the towing mode is selected or not. When a negative determination is made at step S10b, one cycle of execution of the control routine is terminated. When an affirmative determination is made at step S10b, step S20b corresponding to function of the driving-mode control portion 96 is implemented to determine whether the towing mode is the first towing mode or not. When an affirmative determination is made at step S20b, step S30b corresponding to function of the engine control portion 92a is implemented to control the operation state of the engine 12 in accordance with the engine operation condition REQeng in case of selection of the first towing mode. When a negative determination is made at step S20b, the step S40b corresponding to function of the engine control portion 92a is implemented to control the operation state of the engine 12 in accordance with the engine operation condition REQeng in case of selection of the second towing mode. It is noted that, in the present second embodiment, the control routine shown in FIG. 3 as well as the control routine shown in FIG. 5 may be executed.

As described above, in the present second embodiment, the engine operation condition REQeng is determined such that the engine operation ratio Reng of the engine 12 is higher in the case in which the first towing mode is selected, than in the case in which the second towing mode is selected. This control arrangement makes it possible to easily secure the sufficient drive force Fr in the case in which the first towing mode is selected, and to easily improve the energy efficiency in the case in which the second towing mode is selected. That is, even in the towing mode in which the large drive force Fr is required when the vehicle 200 is to start running and is to be accelerated, it is possible to increase the situation in which the engine 12 is in the stopped state. It is therefore possible to improve the energy efficiency while suppressing the reduction of the drivability of the vehicle 200.

In the present second embodiment, the towed vehicle towed by the vehicle 200 in the second towing mode has the total weight lighter than the total weight of the towed vehicle towed by the vehicle 200 in the first towing mode. Therefore, it is possible to increase the situation in which the engine 12 is in the stopped state, in the second towing mode in which the power performance is less important than in the first towing mode.

In the present second embodiment, the first towing mode is selected when the vehicle 200 is to run while towing the towed vehicle during execution of the manual drive control CTmd, and the second towing mode is selected when the vehicle 200 is to run while towing the towed vehicle during execution of the drive assist control CTsd. Therefore, it is possible to increase the situation in which the engine 12 is in the stopped state, during execution of the drive assist control CTsd during which the required drive force Fr tends to have the higher degree of freedom than during execution of the manual drive control CTmd, although the second towing mode as well as the first towing mode is the towing mode.

In the present second embodiment, the first towing mode is selected when the vehicle 200 is to run while towing the towed vehicle during execution of the charge-amount sustaining mode, and the second towing mode is selected when the vehicle 200 is to run while towing the towed vehicle during execution of the charge-amount consuming mode during which the EV running can be continued more than during execution of the charge-amount sustaining mode. Therefore, it is possible to increase the situation in which the engine 12 is in the stopped state, during execution of the charge-amount consuming mode during which the energy efficiency rather than the power performance is more important as compared with during execution of the charge-amount sustaining mode, although the second towing mode as well as the first towing mode is the towing mode.

In the present second embodiment, the first towing mode is selected when the vehicle 200 is to run while towing the towed vehicle with the engine brake mode being selected, and the second towing mode is selected when the vehicle 200 is to run while towing the towed vehicle with the regenerative brake mode being selected. Therefore, it is possible to increase the situation in which the engine 12 is in the stopped state, in the regenerative brake mode in which the energy efficiency is more important, than in the engine brake mode in which the engine 12 requires to be kept in the rotated state, although the second towing mode as well as the first towing mode is the towing mode.

In the present second embodiment, the first towing mode is selected when the vehicle 200 is to run while towing the towed vehicle with the AWD mode being selected, and the second towing mode is selected when the vehicle 200 is to run while towing the towed vehicle with the 2WD mode being selected. Therefore, it is possible to increase the situation in which the engine 12 is in the stopped state, in the 2WD mode in which the power performance is less important, than in the AWD mode, although the second towing mode as well as the first towing mode is the towing mode.

### Third Embodiment

In the above-described second embodiment, there has been described, by way of example, the control by which the engine operation condition REQeng is changed depending on which one of the first and second towing modes is selected, such that the engine operation condition REQeng in the case in which the first towing mode is selected is different from the engine operation condition REQeng in the case in which the second towing mode is selected. However, where the AWD mode is categorized into a plurality of kinds of AWD modes (rather than where the towing mode is categorized into the plurality of kinds of towing modes) in the vehicle 200, it is possible to execute a control by which the engine operation condition REQeng is varied depending on which one of the plurality of kinds of AWD modes is selected.

Specifically, in the present third embodiment, the AWD mode, which is one of the driving modes, is categorized into a first AWD mode and a second AWD mode which are different from each other and which are the same as each other in that the vehicle 200 runs with the drive power being distributed to the front wheels 14 as well as to the rear wheels 16. That is, in this second embodiment, the driving modes include the first AWD mode and the second AWD mode, each of which corresponds to the AWD mode. The engine operation condition REQeng is determined such that the engine operation condition REQeng is higher in a case in which the first AWD mode is selected, than in a case in which the second AWD mode is selected. It is noted that, where the AWD mode is categorized into the low-gear AWD mode and the high-gear AWD mode, each of the first and second AWD modes is categorized into the low-gear AWD mode and the high-gear AWD mode.

It is desirable that the engine 12 is started in an earlier stage so as to securely secure the required drive force Fr in the first AWD mode as compared with in the second AWD mode. To this end, the engine operation condition REQeng includes an engine start condition that is determined such that the starting of the engine 12 is initiated at a point of time at which the first AWD mode is selected in a case in which the first AWD mode is selected when the vehicle 200 is in the predetermined state STvf. Further, the engine start condition is determined such that, in a case in which the second AWD mode is selected when the vehicle 200 is in the predetermined state STvf, the starting of the engine 12 is initiated at a point of time at which the predetermined request REQvf is made in the vehicle 200 after the second AWD mode is selected. The predetermined request REQvf is, for example, the acceleration request that increases the drive force, which is made, for example, when the driver requested drive force Frdemd or the system requested drive force Frdems is increased.

The first AWD mode is an AWD mode to be selected when the manual drive control CTmd is executed, while the second AWD mode is an AWD mode to be selected when the drive assist control CTsd is executed.

The first AWD mode is an AWD mode to be selected when the charge-amount sustaining mode is executed, while the second AWD mode is an AWD mode to be selected when the charge-amount consuming mode is executed.

The first AWD mode is an AWD mode to be selected when the engine brake mode is selected, while the second AWD mode is an AWD mode to be selected when the regenerative brake mode is selected.

In the towing mode, a large drive force Fr is necessarily required in the towing mode when the vehicle 10 is to start running or is to be accelerated. On the other hand, when the towing mode is not selected, there is a case in which a large drive force Fr is not necessarily required. Therefore, the first AWD mode is an AWD mode to be selected when the towing mode is selected, while the second AWD mode is an AWD mode to be selected when the towing mode is not selected.

As described above, basically, the first AWD mode is a AWD mode in which the power performance is important, while the second AWD mode is an AWD mode in which the energy efficiency is important.

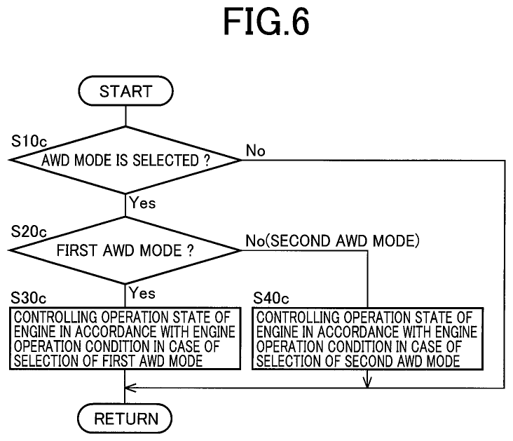

FIG. 6 is a flow chart showing a main part of a control routine executed by the electronic control apparatus 90, namely, a control routine that is executed for suppressing reduction of the drivability of the vehicle and improving the energy efficiency, wherein the control routine is different from those shown in FIGS. 3 and 5. This control routine is executed, for example, in a repeated manner.

As shown in FIG. 6, this control routine is initiated with step S10c corresponding to function of the driving-mode control portion 96, which is implemented to determine whether the AWD mode is selected or not. When a negative determination is made at step S10c, one cycle of execution of the control routine is terminated. When an affirmative determination is made at step S10c, step S20c corresponding to function of the driving-mode control portion 96 is implemented to determine whether the AWD mode is the first AWD mode or not. When an affirmative determination is made at step S20c, step S30c corresponding to function of the engine control portion 92a is implemented to control the operation state of the engine 12 in accordance with the engine operation condition REQeng in case of selection of the first AWD mode. When a negative determination is made at step S20c, the step S40c corresponding to function of the engine control portion 92a is implemented to control the operation state of the engine 12 in accordance with the engine operation condition REQeng in case of selection of the second AWD mode. It is noted that, in the present third embodiment, the control routine shown in FIG. 3 as well as the control routine shown in FIG. 6 may be executed.

As described above, in the present third embodiment, the engine operation condition REQeng is determined such that an engine operation ratio Reng of the engine 12 is higher in the case in which the first AWD mode is selected, than in the case in which the second AWD mode is selected. This control arrangement makes it possible to easily secure the sufficient drive force Frin the case in which the first AWD mode is selected, and to easily improve the energy efficiency in the case in which the second AWD mode is selected. That is, even in the AWD mode in which the large drive force Fr is required, it is possible to increase the situation in which the engine 12 is in the stopped state. It is therefore possible to improve the energy efficiency while suppressing the reduction of the drivability of the vehicle 200.

In the present third embodiment, the first AWD mode is selected when the vehicle 200 is to run with the drive force Fr being distributed to the main drive wheels and the auxiliary drive wheels during execution of the manual drive control CTmd, and the second AWD mode is selected when the vehicle 200 is to run with the drive force Fr being distributed to the main drive wheels and the auxiliary drive wheels during execution of the drive assist control CTsd. Therefore, it is possible to increase the situation in which the engine 12 is in the stopped state, during execution of the drive assist control CTsd during which the required drive force Fr tends to have the higher degree of freedom than during execution of the manual drive control CTmd, although the second AWD mode as well as the first AWD mode is the AWD mode.

In the present third embodiment, the first AWD mode is selected when the vehicle 200 is to run with the drive force Fr being distributed to the main drive wheels and the auxiliary drive wheels during execution of the charge-amount sustaining mode, and the second AWD mode is selected when the vehicle 200 is to run with the drive force Fr being distributed to the main drive wheels and the auxiliary drive wheels during execution of the charge-amount consuming mode during which the EV running can be continued more than during execution of the charge-amount sustaining mode. Therefore, it is possible to increase the situation in which the engine 12 is in the stopped state, during execution of the charge-amount consuming mode during which the energy efficiency rather than the power performance is more important as compared with during execution of the charge-amount sustaining mode, although the second AWD mode as well as the first AWD mode is the AWD mode.

In the present third embodiment, the first AWD mode is selected when the vehicle 200 is to run with the drive force Fr being distributed to the main drive wheels and the auxiliary drive wheels with the engine brake mode being selected, and the second AWD mode is selected when the vehicle 200 is to run with the drive force Fr being distributed to the main drive wheels and the auxiliary drive wheels with the regenerative brake mode being selected. Therefore, it is possible to increase the situation in which the engine 12 is in the stopped state, in the regenerative brake mode in which the energy efficiency is more important, than in the engine brake mode in which the engine 12 requires to be kept in the rotated state, although the second AWD mode as well as the first AWD mode is the AWD mode.

In the present third embodiment, the first AWD mode is selected when the vehicle 200 is to run with the drive force Fr being distributed to the main drive wheels and the auxiliary drive wheels with the towing mode being selected, and the second AWD mode is selected when the vehicle 200 is to run with the drive force Fr being distributed to the main drive wheels and the auxiliary drive wheels with the towing mode being not selected. Therefore, it is possible to increase the situation in which the engine 12 is in the stopped state, when the towing mode is not selected with the power performance being less important than when the towing mode is selected, although the second AWD mode as well as the first AWD mode is the AWD mode.

While the preferred embodiments of this invention have been described in detail by reference to the drawings, it is to be understood that the invention may be otherwise embodied.

For example, in the above-described embodiments, the driving modes such as the towing mode, 2WD mode and AWD mode are selected manually by the vehicle driver. However, the driving modes may be selected automatically by the electronic control apparatus 90, depending on the accelerator opening degree θacc, wheel speed Nr, longitudinal acceleration Gx and yaw rate Ryaw, for example.

In the above-described second embodiment, the engine operation condition REQeng is varied depending on which one of the plurality of kinds of towing modes is selected. In the second embodiment, the vehicle 200 may be, for example, a 2WD vehicle that is not provided with the driving-state selection dial switch 82, transfer 26 and ADD mechanism 37, for example, where the engine operation condition REQeng is not varied depending on which one of the AWD mode and the 2WD mode is selected. That is, in the second embodiment, the vehicle 200 may be any kind of vehicle as long as the vehicle includes means for providing controls and driving modes that are required for enabling the engine operation condition REQeng to be varied depending on which one of the plurality of kinds of towing modes is selected.

In the above-described third embodiment, the engine operation condition REQeng is varied depending on which one of the plurality of kinds of AWD modes is selected. In the third embodiment, the vehicle 200 may be, for example, a vehicle which is not provided with the towing-mode selection switch 81 and in which the towing mode is not included in the driving modes, where the engine operation condition REQeng is not varied depending on whether the towing mode is selected or not. That is, in the third embodiment, the vehicle 200 may be any kind of vehicle as long as the vehicle includes means for providing controls and driving modes that are required for enabling the engine operation condition REQeng to be varied depending on which one of the plurality of kinds of AWD modes.

In the above-described second and third embodiments, where the charge-amount sustaining mode and the charge-amount consuming mode are included in the driving modes, the vehicle 200 may be a so-called plug-in-hybrid electric vehicle in which the battery 54 can be charged with an electric power supplied from an external power source such as a charging station and a household power. The control, by which the engine operation condition REQeng is varied depending on which one of the charge-amount sustaining mode and the charge-amount consuming mode is established, is useful for a plug-in-hybrid electric vehicle.

In the above-described embodiments, where the vehicle (10; 200) is provided with a starter serving as a motor to be used exclusively for cranking the engine 12, it is possible to employ a method of starting the engine 12 by igniting the engine 12 after cranking the engine 12 by the starter, in a case in which the cranking cannot be made at all or satisfactorily by the electric motor MG for example, due to an extremely low outside temperature when the vehicle (10; 200) has been stopped with the MG rotational speed Nm being zero.

In the above-described embodiments, the automatic transmission 24 is an automatic transmission of a planetary gear type. However, the automatic transmission 24 may be any one of other type transmissions such as a known belt-type continuously variable transmission and a synchronous mesh twin shaft parallel axis-type automatic transmission including a known DCT (Dual Clutch Transmission).

In the above-described embodiments, the vehicle (10; 200) is an AWD vehicle based on a 2WD vehicle of FR system, and is a parallel-type hybrid electric vehicle in which the drive power from the engine 12 and the electric motor MG is to be transmitted to the rear wheels 16 and optionally the front wheels 14. However, the present invention is applicable to also an AWD vehicle based on a 2WD vehicle of FR (front engine and rear drive) system, a hybrid electric vehicle including a known electrically-operated continuously-variable transmission, and a series-type hybrid electric vehicle in which the drive power is to be transmitted to the drive wheels, wherein the drive power is to be generated by an electric motor that is driven by an electric power of the battery and/or an electric power of the generator driven by a power of the engine. In the series-type hybrid electric vehicle, the automatic transmission may be either present or absent.

In the above-described embodiments, the AWD system does not necessarily have to be provided with the transfer 26 and the ADD mechanism 37. For example, the auxiliary drive wheels may be driven by an electric motor that is other than the electric motor by which the main drive wheels are to be driven. Further, in the AWD system, the switching may be made simply between the 2WD mode and the AWD mode, without the auxiliary transmission 106 being included in the transfer 26. In this case without the auxiliary transmission 106 being included in the transfer 26, the MG idling control is not executed in preparation for the switching from the high-gear AWD mode to the low-gear AWD mode in the above-described first embodiment. Moreover, in the above-described third embodiment, the AWD system may be a system in which the AWD mode is always established without the 2WD mode being established.

In the above-described embodiments, the fluid-type transmission device in the form of the torque converter 22 is provided in the power transmission apparatus 18. However, the provision of the torque converter 22 is not essential. For example, the fluid-type transmission device may be constituted by, in place of the torque converter 22, by another fluid-type transmission device such as a fluid coupling device without a function of torque boost effect. Moreover, the fluid-type transmission device does not necessarily have to be provided but may be replaced by a starting clutch, for example.

It is to be understood that the embodiments described above are given for illustrative purpose only, and that the present invention may be embodied with various modifications and improvements which may occur to those skilled in the art.

### NOMENCLATURE OF ELEMENTS

10: vehicle (hybrid electric vehicle)
12: engine
14: front wheel (auxiliary drive wheel)
16: rear wheel (main drive wheel)
18: power transmission apparatus (vehicle power transmission apparatus)
26: transfer (drive-power distribution device)
48: transmission output shaft (output rotary member)
54: battery (electric storage device)
90: electronic control apparatus (control apparatus)
92a: engine control portion
92b: electric-motor control portion
96: driving-mode control portion
98: driving control portion
106: auxiliary transmission (transmission)
120: auxiliary-transmission dog clutch (dog clutch)
200: vehicle (hybrid electric vehicle)
MG: electric motor

What is claimed is:

1. A control apparatus for a hybrid electric vehicle that includes an engine, an electric motor, main and auxiliary drive wheels and a drive-power distribution device configured to distribute a drive power to the main and auxiliary drive wheels,
the control apparatus comprising:
an engine control portion configured to control an operation state of the engine in accordance with an engine operation condition for starting and stopping the engine; and
a driving-mode control portion configured to control running of the vehicle so as to realize selected at least one of driving modes which is selected by a driver of the vehicle or which is automatically selected,
wherein the driving modes include a towing mode in which the vehicle is to run while towing a towed vehicle, a main-drive-wheel driving mode in which the vehicle is to run with the drive power being distributed to the main drive wheels, and an all-wheel driving mode in which the vehicle is to run with the drive power being distributed to the main drive wheels and the auxiliary drive wheels, and
wherein the engine operation condition is determined such that an engine operation ratio, which is a ratio of an operation time of the engine to an operation time of the vehicle, is higher in a case in which the towing mode is selected, than in a case in which the all-wheel driving mode is selected without the towing mode being selected.

2. The control apparatus according to claim 1,
wherein the engine operation condition is determined such that the engine operation ratio is higher in a case in which the towing mode or the all-wheel driving mode is selected, than in the case in which the main-drive-wheel driving mode is selected without the towing mode being selected.

3. The control apparatus according to claim 2,
wherein the engine operation condition includes an engine intermittent-operation condition related to an engine intermittent operation in which the engine is placed alternately in an operated state and a stopped state, and
wherein the engine intermittent-operation condition is determined, such that the engine intermittent operation is inhibited in the case in which the towing mode or the all-wheel driving mode is selected, and such that the engine intermittent operation is allowed in the case in which the main-drive-wheel driving mode is selected without the towing mode being selected.

4. The control apparatus according to claim 1,
wherein the engine operation condition includes an engine start condition related to starting of the engine, and
wherein the engine start condition is determined, such that, in a case in which the towing mode is selected when the vehicle is in a predetermined state, the starting of the engine is initiated at a point of time at which the towing mode is selected, and such that, in a case in which the all-wheel driving mode is selected without the towing mode being selected when the vehicle is in the predetermined state, the starting of the engine is initiated at a point of time at which a predetermined request is made in the vehicle after the all-wheel driving mode is selected.

5. The control apparatus according to claim 4,
wherein the vehicle includes a vehicle power transmission apparatus including the drive-power distribution device and configured to transmit the drive power toward the main and auxiliary drive wheels,
wherein the predetermined state is (i) a state in which the vehicle is stopped with the vehicle power transmission apparatus being placed in a forward driving position that enables the drive power to be transmitted to drive the vehicle in a forward direction, or (ii) a state in which the vehicle is stopped with the vehicle power transmission apparatus being placed in a neutral position that disables the drive power to be transmitted without an output rotary member of the vehicle power transmission apparatus being mechanically fixed to be unrotatable, and
wherein the predetermined request is (iii) a request of an acceleration of the vehicle that increases the drive power, or (iv) a request of a charge of an electric storage device configured to supply and receive an electric power to and from the electric motor.

6. The control apparatus according to claim 4,
wherein the drive-power distribution device includes a transmission in which a selected one of a low gear position and a high gear position is to be established by operation of a dog clutch,
wherein the all-wheel driving mode is categorized into a low-gear all-wheel driving mode in which the low gear position is established in the transmission and a high-gear all-wheel driving mode in which the high gear position is established in the transmission,
wherein the main-drive-wheel driving mode is a high-gear main-drive-wheel driving mode in which the high gear position is established in the transmission, and
wherein the control apparatus further comprises an electric-motor control portion that is configured to cause the electric motor to output a predetermined torque causing a creep phenomenon in a state in which the engine is held in the stopped state, in a case in which the high-gear main-drive-wheel driving mode is switched to the high-gear all-wheel driving mode with the high-gear all-wheel driving mode being selected in the high-gear main-drive-wheel driving mode when each of the engine and the electric motor is in the stopped state.

7. A control apparatus for a hybrid electric vehicle that includes an engine and an electric motor,
the control apparatus comprising:
an engine control portion configured to control an operation state of the engine in accordance with an engine operation condition for starting and stopping the engine; and
a driving-mode control portion configured to control running of the vehicle so as to realize selected at least one of driving modes which is selected by a driver of the vehicle or which is automatically selected,
wherein the driving modes include a first towing mode in which the vehicle is to run while towing a towed vehicle, and a second towing mode in which the vehicle is to run while towing a towed vehicle, and
wherein the engine operation condition is determined such that an engine operation ratio, which is a ratio of an operation time of the engine to an operation time of the vehicle, is higher in a case in which the first towing mode is selected, than in a case in which the second towing mode is selected.

8. The control apparatus according to claim 7,
wherein the towed vehicle towed by the vehicle in the second towing mode has a total weight lighter than a total weight of the towed vehicle towed by the vehicle in the first towing mode.

9. The control apparatus according to claim 7, further comprising:
a driving control portion configured to execute (i) a manual drive control for driving the vehicle in accordance with driving operations made by the driver of the vehicle and (ii) a drive assist control for driving the vehicle by automatically performing at least acceleration and deceleration of the vehicle,
wherein the first towing mode is selected when the vehicle is to run while towing the towed vehicle during execution of the manual drive control, and
wherein the second towing mode is selected when the vehicle is to run while towing the towed vehicle during execution of the drive assist control.

10. The control apparatus according to claim 7,
wherein the driving modes include a charge-amount sustaining mode and a charge-amount consuming mode,
wherein, in the charge-amount sustaining mode, an engine intermittent operation in which the engine is placed alternately in an operated state and a stopped state is executed, and a motor driving of the vehicle with only the electric motor serving as a drive power source is enabled when the engine is in the stopped state,
wherein, in the charge-amount consuming mode, the motor driving is continued more than in the charge-amount sustaining mode,
wherein the first towing mode is selected when the vehicle is to run while towing the towed vehicle during execution of the charge-amount sustaining mode, and
wherein the second towing mode is selected when the vehicle is to run while towing the towed vehicle during execution of the charge-amount consuming mode.

11. The control apparatus according to claim 7,
wherein the driving modes include an engine brake mode and a regenerative brake mode,
wherein, in the engine brake mode, an engine brake torque owing to resistance to rotation of the engine is generated by during deceleration running of the vehicle,
wherein, in the regenerative brake mode, a regenerative brake torque owing to regeneration of the electric motor, rather than the engine brake torque, is preferentially generated during the deceleration running of the vehicle,
wherein the first towing mode is selected when the vehicle is to run while towing the towed vehicle with the engine brake mode being selected, and
wherein the second towing mode is selected when the vehicle is to run while towing the towed vehicle with the regenerative brake mode being selected.

12. The control apparatus according to claim 7,
wherein the vehicle further includes main and auxiliary drive wheels and a drive-power distribution device configured to distribute a drive power to the main and auxiliary drive wheels,
wherein the driving modes include an all-wheel driving mode and a main-drive-wheel driving mode,
wherein, in the all-wheel driving mode, the vehicle is to run with the drive power being distributed through the drive-power distribution device to the main drive wheels and the auxiliary drive wheels,
wherein, in the main-drive-wheel driving mode, the vehicle is to run with the drive power being distributed through the drive-power distribution device to the main drive wheels,
wherein the first towing mode is selected when the vehicle is to run while towing the towed vehicle with the all-wheel driving mode being selected, and
wherein the second towing mode is selected when the vehicle is to run while towing the towed vehicle with the main-drive-wheel driving mode being selected.

13. A control apparatus for a hybrid electric vehicle that includes an engine, an electric motor, main and auxiliary drive wheels and a drive-power distribution device configured to distribute a drive power to the main and auxiliary drive wheels,
the control apparatus comprising:
an engine control portion configured to control an operation state of the engine in accordance with an engine operation condition for starting and stopping the engine; and
a driving-mode control portion configured to control running of the vehicle so as to realize selected at least one of driving modes which is selected by a driver of the vehicle or which is automatically selected,
wherein the driving modes include a first all-wheel driving mode in which the vehicle is to run with the drive power being distributed to the main drive wheels and the auxiliary drive wheels, and a second all-wheel driving mode in which the vehicle is to run with the drive power being distributed to the main drive wheels and the auxiliary drive wheels, and
wherein the engine operation condition is determined such that an engine operation ratio, which is a ratio of an operation time of the engine to an operation time of the vehicle, is higher in a case in which the first all-wheel driving mode is selected, than in a case in which the second all-wheel driving mode is selected.

14. The control apparatus according to claim 13, further comprising:
a driving control portion configured to execute (i) a manual drive control for driving the vehicle in accordance with driving operations made by the driver of the vehicle and (ii) a drive assist control for driving the vehicle by automatically performing at least acceleration and deceleration of the vehicle,
wherein the first all-wheel driving mode is selected when the vehicle is to run with the drive power being distributed to the main drive wheels and the auxiliary drive wheels during execution of the manual drive control, and
wherein the second all-wheel driving mode is selected when the vehicle is to run with the drive power being distributed to the main drive wheels and the auxiliary drive wheels during execution of the drive assist control.

15. The control apparatus according to claim 13,
wherein the driving modes include a charge-amount sustaining mode and a charge-amount consuming mode,
wherein, in the charge-amount sustaining mode, an engine intermittent operation in which the engine is placed alternately in an operated state and a stopped state is executed, and a motor driving of the vehicle with only the electric motor serving as a drive power source is enabled when the engine is in the stopped state,
wherein, in the charge-amount consuming mode, the motor driving is continued more than in the charge-amount sustaining mode,
wherein the first all-wheel driving mode is selected when the vehicle is to run with the drive power being distributed to the main drive wheels and the auxiliary drive wheels during execution of the charge-amount sustaining mode, and
wherein the second all-wheel driving mode is selected when the vehicle is to run with the drive power being distributed to the main drive wheels and the auxiliary drive wheels during execution of the charge-amount consuming mode.

16. The control apparatus according to claim 13,
wherein the driving modes include an engine brake mode and a regenerative brake mode,
wherein, in the engine brake mode, an engine brake torque owing to resistance to rotation of the engine is generated by during deceleration running of the vehicle,
wherein, in the regenerative brake mode, a regenerative brake torque owing to regeneration of the electric motor, rather than the engine brake torque, is preferentially generated during the deceleration running of the vehicle,
wherein the first all-wheel driving mode is selected when the vehicle is to run with the drive power being distributed to the main drive wheels and the auxiliary drive wheels with the engine brake mode being selected, and
wherein the second all-wheel driving mode is selected when the vehicle is to run with the drive power being distributed to the main drive wheels and the auxiliary drive wheels with the regenerative brake mode being selected.

17. The control apparatus according to claim 13,
wherein the driving modes include a towing mode in which the vehicle is to run while towing a towed vehicle,
wherein the first all-wheel driving mode is selected when the vehicle is to run with the drive power being distributed to the main drive wheels and the auxiliary drive wheels with the towing mode being selected, and
wherein the second all-wheel driving mode is selected when the vehicle is to run with the drive power being distributed to the main drive wheels and the auxiliary drive wheels with the towing mode being not selected.
